(19) United States
(12) Patent Application Publication
(10) Pub. No.: US 2026/0106173 A1
(43) Pub. Date: Apr. 16, 2026

(54) CURRENT COLLECTORS FOR BATTERY ELECTRODES

(71) Applicant: Coreshell Technologies, Incorporated, San Leandro, CA (US)

(72) Inventors: Sourav Roger Basu, El Cerrito, CA (US); Jonathan Tan, Oakland, CA (US); Bonil Koo, San Leandro, CA (US); Donald A. Zehnder, San Carlos, CA (US); Rachael Lee, Berkeley, CA (US)

(21) Appl. No.: 19/115,973

(22) PCT Filed: Sep. 27, 2023
(86) PCT No.: PCT/US2023/075270

§ 371 Date: Mar. 27, 2025

Related U.S. Application Data
(60) Provisional application No. 63/377,319, filed on Sep. 27, 2022.
(60) Provisional application No. 63/505,896, filed on Jun. 2, 2023.

(51) Int. Cl. H01M 4/66; H01M 4/02; H01M 4/04; H01M 4/62; H01M 4/75; H01M 10/0525

(52) U.S. Cl. CPC H01M 4/668; H01M 4/0404; H01M 4/0419; H01M 4/0471; H01M 4/623; H01M 4/625; H01M 4/661; H01M 4/667; H01M 4/75; H01M 10/0525; H01M 2004/021

(57) ABSTRACT

A device can include a battery electrode that comprises a substrate having one or more polymeric materials and a layer disposed on the substrate. The layer can include one or more conductive materials, have a thickness no greater than 12 micrometers, and have a porosity of at least 5% by volume. Additionally, an electrode layer including a seed layer can comprise a number of fused nanoparticles. The electrode layer can also include a lithium metal layer disposed on the number of fused nanoparticles. The electrode layer can be formed by producing, on a polymeric current collector layer, a seed layer that includes nanoparticles. A formulation to form the seed layer can include nanoparticles having ligands and then removing the ligands using one or more thermal and/or one or more chemical treatment processes. The seed layer can be electrically conductive, acting as the current collector when disposed on a polymeric substrate.

### CROSS-REFERENCE TO RELATED APPLICATION

This patent application claims the benefit of priority to U.S. Provisional Application Ser. No. 63/377,319, filed on Sep. 27, 2022, and U.S. Provisional Application Ser. No. 63/505,896, filed Jun. 2, 2023, which are both incorporated by reference herein in their entirety.

### FIELD OF THE DISCLOSURE

Implementations of the present disclosure generally relate to compositions of electrodes and the methods of fabrication thereof in lithium-ion batteries.

### BACKGROUND

Lithium-Ion Batteries (LIBs) can be used in a number of applications, such as in portable electronics, electric vehicles, and electrified aviation. State of the art LIBs possess limited cell-level energy density due to the low specific energy of their Lithium-containing active materials, namely the graphite anode and the metal oxide or metal phosphate cathode. Improvements in the energy density of LIBs may lead to increased adoption and viability as an energy source.

One way to improve the energy density of LIBs is to replace the standard graphite anode with an anode composed of Li metal. Li metal possesses a specific capacity of ˜3860 mAh/g, more than ten times that of graphite. Furthermore, the potential at which Li metal is deposited onto a current collector from a typical Li battery electrolyte (0V vs. Li/Li⁺, −3.04V vs. standard hydrogen electrode (SHE)) is also improved relative to graphite; graphite typically intercalates Li at a range of voltages from 0.005 to 0.5V vs. Li/Li⁺. The combination of these two attributes results in an improved energy density of Li metal anodes as compared to graphite anodes.

Furthermore, secondary lithium-ion battery electrodes require at least two components: (1) an active material that reversibly stores and releases lithium ions, and (2) an electrically conductive current collector in intimate contact with the active material that facilitates the electron transport necessary for the active material to reversibly intercalate or alloy lithium at reasonable rates. In order for a material to serve solely as a current collector, and not as an active material, it must be electrically conductive without itself alloying or intercalating lithium within the voltage range of interest. The subset of materials that satisfy such criteria is limited; on the anode side examples include copper, nickel, titanium, and iron, among a few others. In particular, copper is widely employed as an anode current collector in lithium-ion batteries due to its high electrical conductivity, ductility, abundance and minimal reaction with lithium.

### BRIEF DESCRIPTION OF THE DRAWINGS

The accompanying drawings, which are incorporated in and constitute a part of this specification, illustrate certain implementations, and together with the written description, serve to explain certain principles of the methods, systems, and devices disclosed herein. The description provided herein is better understood when read in conjunction with the accompanying drawings which are included by way of example and not by way of limitation. It will be understood that like reference numerals identify like components throughout the drawings, unless the context indicates otherwise. It will also be understood that some or all of the figures may be schematic representations for purposes of illustration and do not necessarily depict the actual relative sizes or locations of the elements shown.

FIG. 1 illustrates a flow diagram of an example process to produce porous current collector layers for lithium-ion batteries, in accordance with one or more examples.

FIG. 2 illustrates a device that includes an active material layer disposed on a porous current collector layer of a lithium-ion battery that is comprised of spherical conductive particles, in accordance with one or more examples.

FIG. 3 illustrates a device that includes active material particles included in a layer that is also comprised of spherical conductive particles of a lithium-ion battery, in accordance with one or more examples.

FIG. 4 illustrates a device that includes an active material layer disposed on a porous current collector layer of a lithium-ion battery that is comprised of conductive nanowires, in accordance with one or more examples.

FIG. 5 illustrates a device that includes active material particles included in a layer that is also comprised of conductive nanowires, in accordance with one or more examples.

FIG. 6 illustrates a device that includes an active material layer disposed on a porous current collector layer of a lithium-ion battery that is comprised of spherical conductive particles and on a porous polymeric substrate, in accordance with one or more examples.

FIG. 7 is a diagram of a process to produce a nanoparticle seed layer on a surface of a current collector layer.

FIG. 8 is a diagram illustrating an example process to produce a lithium metal coated substrate.

### SUMMARY

The following presents a simplified summary of one or more implementations of the present disclosure in order to provide a basic understanding of such implementations. This summary is not an extensive overview of all contemplated implementations and is intended to neither identify key or critical elements of all implementations, nor delineate the scope of any or all implementations.

The methods and compositions of the present disclosure describe lithium-ion battery electrodes. The methods and compositions disclosed herein enable lithium-ion batteries with substantially higher gravimetric energy density than the state-of-the-art, without compromising other salient battery performance metrics. The methods disclosed herein are more commercially and technically feasible for introduction into high-volume lithium-ion battery (LIB) manufacturing than alternate methods of fabrication of lithium-ion battery electrodes and metallized polymer current collectors. The compositions disclosed herein are more commercially and technically feasible for introduction into high-volume lithium-ion battery (LIB) manufacturing than alternate compositions relating to lithium-ion battery electrodes and metallized polymer current collectors. Additionally, implementations herein are directed to seed layers deposited on current collector layers that increases the available surface area for lithium deposition while minimizing thickness of lithium-ion battery electrodes. In some instances, the seed layer itself may also function as the current collector.

In one or more examples, a device comprises a battery electrode including a substrate having one or more polymeric materials and a layer disposed on the polymeric substrate. The layer includes one or more conductive materials, has a thickness no greater than 12 micrometers, and has a measure of porosity of at least 5% by volume.

In one or more additional examples, a method comprises providing a substrate for a battery electrode, where the substrate includes one or more polymeric materials. The method also includes forming a layer on the substrate. The layer includes one or more conductive materials, has a thickness no greater than 12 micrometers, and has a measure of porosity of at least 5% by volume.

In one or more further examples, a formulation comprises one or more solvents, first particles comprised of one or more conductive materials, and second particles comprised of one or more electrode active materials.

In still other examples, a seed layer for a Li metal anode can be generated that includes nanoparticles. The seed layer can be formed on a current collector layer and Li metal can be deposited on the seed layer. The seed layer can have an amount of porosity. In various examples, the seed layer can be formed from nanoparticles having ligands coupled to the nanoparticles and then removing the ligands using one or more thermal treatment processes and/or one or more chemical treatment processes. In at least some examples, the seed layer can comprise nanoparticles that are formed in situ, during the decomposition of molecular precursors. The nanoparticles of the seed layer can be present in nanoparticle clusters comprised of fused groups of nanoparticles. Li metal can be deposited on the seed layer to produce an anode of a battery cell.

In various examples, a method for producing a substrate comprising a nanostructured seed layer on one or more surfaces of a current collector can include providing an ink comprising a solution comprising at least ligand-functionalized nanoparticles and a solvent; applying a thin wet film of the ink to the current collector using a solution-phase thin-film coating process; drying the thin wet film to produce a thin dry film of ligand-functionalized nanoparticles; and performing one or more thermal treatments and/or chemical treatments to the thin dry film, thereby producing a substrate comprising a free-standing, porous nanostructured seed layer on one or more surfaces of a current collector.

In one or more examples, a method for producing a substrate comprising a nanostructured seed layer on one or more surfaces of a current collector can include providing an ink comprising a solution comprising at least one or more molecular precursors and a solvent. Additionally, a thin wet film of the ink can be applied to the current collector using a solution-phase thin-film coating process. The current collector may comprise a polymer material, such as polyethylene, polypropylene, polyimide, polyether ether ketone, polyester, polyamide or polyethylene napthalate. In one or more additional examples, the current collector may comprise a polymer material, such as polyethylene, polypropylene, polyimide, polyether ether ketone, polyester, polyamide or polyethylene napthalate, in addition to a metal, such as copper, titanium, nickel, or stainless steel. In one or more further examples, the current collector may be entirely composed of a polymer material, such as polyethylene, polypropylene, polyimide, polyether ether ketone, polyester, polyamide or polyethylene napthalate. In at least some examples, the nanostructured seed layer deposited on the current collector can be electrically conductive, to provide current-carrying capability. One or more thermal treatments and/or chemical treatments can be performed with respect to the thin wet film, thereby producing a substrate comprising a free-standing, porous nanostructured seed layer on one or more surfaces of a current collector or polymer substrate. The molecular precursors can include metalorganic compounds.

Additionally, the seed layer can be formed from a formulation including a solvent; a plurality of nanoparticles disposed within the solvent, the plurality of nanoparticles having one or more dimensions from about 0.5 nanometers to about 500 nm; one or more ligands coupled to individual nanoparticles of the plurality of nanoparticles. The one or more ligands can have a molecular weight from 20 daltons (Da) to 10 kDa. The formulation can be characterized as an ink that is deposited onto a current collector layer of a battery cell.

Further, a method for producing a lithium-metal coated substrate can include providing a substrate comprising a nanoparticle seed layer on one or more surfaces of a current collector; and electrodepositing lithium onto the nanoparticle seed layer of the substrate to form a lithium metal-coated substrate.

In one or more implementations, a battery can include a housing; one or more battery cells disposed within the housing, an individual battery cell of the one or more battery cells comprising: an electrode layer including (i) a seed layer comprised of a number of fused nanoparticles and (ii) a lithium metal layer disposed on the number of fused nanoparticles; one or more separator layers; and one or more electrolyte layers comprising an electrolyte.

### DETAILED DESCRIPTION

The widespread adoption of Li metal as an anode material has been impeded due to several challenges. Primarily, the morphology of Li metal deposited on the anode current collector during battery charging is typically highly non-uniform and composed of tree-like structures (“dendrites”) or otherwise uneven geometries that tend to become detached from the remainder of the Li metal anode during repeated battery cycling. Such detached Li eventually becomes electrochemically inactive and no longer contributes to battery capacity. In some instances, Li metal dendrites can grow sufficiently long so as to pierce the anode-cathode polymer separator and form an electrical short to the cathode. In these instances, the joule heating resulting from the energy discharged through the electrical short is often enough to force the battery cell into uncontrolled thermal runaway and conflagration.

A related deleterious outcome of uneven Li metal deposition is the continued formation and disintegration of a parasitic surface degradation product formed at the Li metal-electrolyte interface, which is commonly termed solid-electrolyte-interphase (or “SEI”). The formation of SEI results from the thermodynamic instability of typical electrolyte solvents at battery operating voltages. At the anode, in particular, a reductive process dominates whereby the electrolyte solvent molecule first cleaves, then combines with nearby Li ions, and finally precipitates an insoluble, irreversible Li-containing compound. Like detached Li metal, SEI compounds are also electrochemically inactive and contribute to capacity loss. In state-of-the-art LIBs, the SEI forms during the first few charge cycles on the graphite anode surface and then largely limits its own formation in subsequent cycles due to its electrically insulating nature. In graphite anodes, the relatively low volumetric change upon lithiation/de-lithiation (˜10%), coupled with the stability of the host graphite lattice itself, yields an anode-electrolyte interfacial SEI that remains mostly intact throughout the LIB's cycle lifetime. In contrast, due to the unpredictable and uneven deposition of Li metal, large volumetric changes are experienced by SEI on Li metal surfaces during every charge-discharge cycle, resulting in rapid disintegration of the SEI.

In addition, a practical shortcoming of the Li metal anode is the impact of Li metal deposition on the overall cell geometry itself. At the beginning of a LIB's life, all available Li is initially stored in the cathode. In Li metal anode battery cell design, the anode at the beginning of life is a bare foil current collector. Then, during the first charge of the battery, Li from the cathode is transported via the electrolyte to the surface of the current collector, where it electrodeposits as layers of Li metal. During this process, the cathode material undergoes little volumetric change, but the electrodeposited Li metal contributes several additional microns per anode-cathode couple. For example, a cathode with areal capacity of ˜3 mAh/cm² will result in a Li metal thickness of ˜15 um at full charge, assuming bulk Li metal density. In most instances, however the Li metal thickness actually exceeds this value because of the previously described uneven, low-density Li metal morphology. Therefore, in a battery cell composed of several stacked anode-cathode couples, the overall impact to the battery cell thickness can be an increase of several 10's to 100's of microns during the charging process. Given that typical battery cell housings are not engineered with extra volume to accommodate such an expansion in thickness, the deposition of Li metal presents a practical barrier to adoption.

The morphology of electrodeposited Li metal largely depends on the current density at which it is deposited. For example, deposition current densities of ˜0.1 mA/cm² can provide relatively uniform lateral electrodeposition of Li metal, but current densities greater than 1 mA/cm² begin to yield dendritic growth. In a scenario where a Li metal anode is paired with a cathode of >3 mAh/cm² areal capacity, a charge current density of 0.1 mA/cm² represents a charge rate of C/30, 120× lower than the desired minimum fast charge rate of 4 C for EVs. Furthermore, electrodeposited Li metal layers having a fast charge rate of 4 C are typically realized when a moderate compressive stress is applied to the full cell stack. A sufficiently stiff support structure that can withstand this pressure adds substantial mass that diminishes the specific energy gains of using the Li metal anode. Additionally, this application of pressure adds cost and erodes the economic viability of Li metal anodes.

One way to maintain relatively low Li metal electrodeposition current densities and promote lateral growth is to increase the effective surface area of the current collector. For example, a highly textured current collector may have an effective surface area that is orders of magnitude greater than the planar surface area. Such a current collector can accommodate high charge rates from a cathode providing >3 mAh/cm² planar areal capacity, because the effective current density can be maintained well within the acceptable range (e.g., <0.1 mA/cm²) for lateral growth of Li metal.

Furthermore, by providing a stable, volumetrically unchanging scaffold onto which thin layers of Li metal are plated, textured three-dimensional current collectors effectively eliminate the problem of cell swelling during each charge cycle.

Most efforts to date for generating textured current collectors for Li metal deposition have centered around porous metallic “foams”. Such structures are typically fabricated by etching solid planar metallic foils to yield highly porous textured microstructures, or by coating foams of other materials (such as carbon) with thin metallic overlayers. While such metallic foams have yielded some success with regards to preventing dendrite growth during Li metal deposition, they do not provide the most efficient and optimal architecture. Usually, such foams possess high porosity but still low effective surface area as a function of foam thickness due to the relatively large average pore size. The end result is that these foams tend to be several dozens to hundreds of microns thick themselves-thereby greatly reducing the effective volumetric energy density of the resulting battery cell. Furthermore, the fabrication of the foam adds an additional step to the battery manufacturing process, and can often be a costly technique (if for instance, the foam is generated by a high-temperature pyrolysis process).

In addition to ultimately providing an insufficient amount of surface area for Li deposition, the thickness of the Li metal layer on all surfaces within the foam can exceed 100's of nm at full charge. At such repeated volume changes of the Li metal layer, any nascent SEI formed from previous cycles on the surface of the Li metal is still likely to disintegrate, thereby exposing fresh Li metal surface for new SEI to form during each cycle. This results in accelerated capacity fade and poor coulombic efficiency.

Nanoparticles of a variety of materials, across a diversity of geometries (rods, spheres, wires, etc.) can possess exceptional surface area to mass and surface area to volume ratios. Thus, three-dimensional structures composed of nanoparticles can provide a relatively high surface area substrate suitable for relatively uniform, lateral Li metal deposition in comparison to metallic foam architectures. Such architectures can be deposited on top of a separate planar current collector, essentially providing a “seed layer” for the deposition of Li metal, while also providing a low-resistance electrical connection to the current collector itself. Nanoparticles used to construct such a seed layer can be metallic (i.e., possessing low bulk electrical resistivity), and can be packed within the seed layer to a fairly high packing density, while still maintaining sufficient pore volume between particles to provide space for Li metal deposition and a self-limiting SEI. As a result, the seed layer architectures described herein can maximize available surface area for Li deposition while minimizing the thickness of the seed layer architectures. The seed layer architectures also include a minimum pore volume to accommodate growth of the Li metal layer and any associated SEI, while also minimizing the required thickness of the Li metal layer at full charge to prevent disintegration of the SEI due to volumetric growth of the Li metal layer.

The application of nanoparticles to the surface of a current collector can be accomplished by producing stable colloidal suspensions of nanoparticles within a solvent when the nanoparticles are surface-functionalized with appropriate ligands, essentially generating a nanoparticle “ink”. Such inks can also be formulated to a high solid content of nanoparticles without compromising colloidal stability. In some instances, the inks may comprise appropriate molecular precursors, which when exposed to a post-treatment, generate a porous thin solid film comprising nanoparticles. Once a suitable ink has been generated, it can be applied to the surface of a current collector using coating techniques employed to apply solutions or slurries to flat substrates, such as spray or slot-die coating. In various examples, applying the ink to the surface of a current collector can be performed using techniques that can be used to apply graphite active materials to the anode current collector in existing LIB processes, such as slot-die slurry casting process. As a result, from a manufacturing perspective, the existing graphite slot-die coating process can be repurposed to deposit a colloidal nanoparticle ink or a molecular precursor ink instead of a graphite slurry. This provides a manifest advantage for nanoparticle-based seed layers as described herein over other textured three-dimensional current collectors, as the deposition of nanoparticle seed layers can be accomplished using existing standard LIB manufacturing equipment. Whereas, in contrast, applying foam-based nanostructures or microstructures adds operations to existing systems used to manufacture lithium-ion batteries that include graphite coated electrodes.

The ligands used to functionalize the surface of nanoparticles to render them dispersible within a solvent as a colloidal solution play another key role in the formation of a nanoparticle seed layer, namely, that of a pore-generating species. Once a nanoparticle ink is applied to the surface of a current collector, what remains immediately after the application is a “wet” film composed of ligand-functionalized nanoparticles and residual solvent. After the solvent evaporates, what remains is a “dry” film of stacked ligand-functionalized nanoparticles. The dry film can then be exposed to a moderate heat treatment to allow the nanoparticles to bond or “neck”, i.e., form small sintered inter-particle connections. Surface ligands are usually sufficiently labile on nanoparticle surfaces to allow such necking to occur. At the same time, the nanoparticles can also form small, sintered connections to the underlying current collector. Once the nanoparticles have formed sintered connections to each other and to the underlying current collector, the nanoparticles have formed a mechanically stable matrix. Then, the ligands can be removed by another heat treatment or through a chemical treatment, leaving behind empty pores. After removal of the ligands, what remains is a porous, free-standing nanoparticle matrix (the “seed layer”) on top of a current collector, which can then be employed as a substrate for Li metal deposition.

In one or more further examples, nanoparticles can be fused and sintered to themselves and to an underlying current collector to yield a porous, free-standing nanoparticle matrix. In at least some examples, the nanoparticle matrix can be formed from nanoparticles fabricated from inks comprising molecular precursors.

A disadvantage of using copper as a current collector in lithium-ion batteries is its high mass density of approximately 9 gm/cm³. The mass density of copper can lower the gravimetric energy density of a battery that employs it as a current collector in place of a comparatively less dense material. Therefore, any lithium-ion battery design that reduces the amount of copper needed, or which can replace copper with another material possessing similar physical characteristics with lower mass density, will yield an advantage in cell-level gravimetric energy density compared to the state of the art. However, materials similar to copper which possess the necessary attributes of a lithium-ion battery current collector are typically not as abundant as copper, and therefore are cost-prohibitive to use at scale.

Currently, the minimum amount of copper that can be used as an anode current collector in a lithium-ion battery is determined by the minimum thickness to which copper can be readily processed as a foil while still being practically handled as a substrate for active material deposition. Copper can be processed into a foil with thickness as low as approximately 6 microns, but any further reduction in thickness hampers its processability using state-of-the-art “roll-to-roll” equipment.

One way to further reduce copper content in a lithium-ion battery is to deposit copper as a thin film of less than 6 microns on a lower density substrate, such as a polymer, thereby creating a lightweight composite copper-polymer current collector that can be used in place of a dense current collector composed entirely or mostly of copper foil. By utilizing a composite copper-polymer current collector, one could take advantage of copper's high electrical conductivity as well as the low mass density of an appropriately selected polymer.

Metallized polymer substrates are particularly prevalent in food packaging applications, where the metal films provide improved barriers to moisture and light and thereby reduce the rate of spoilage of the packaged food. Examples of metallized polymer packaging materials include thin films of aluminum deposited on polyethylene or polypropylene substrates using roll-to-roll vacuum evaporation processes.

In such applications, the thickness of the deposited aluminum film ranges from single-digit angstroms to tens of nanometers. Such thicknesses are sufficient to provide the desired barrier properties in food packaging applications. However, when employed as a current collector for batteries, copper or aluminum films are thicker—on the order of hundreds of nanometers to several microns—in order to provide the electrical and thermal conductivity necessary for typical battery operation. Depositing such thick layers of metals at high rates on polymer substrates using vacuum evaporation is particularly challenging due to the large heat load experienced by the polymer substrate from the impinging metal flux. Such high heat loads typically raise the temperature of the polymer beyond its glass transition temperature, even when active cooling is concurrently applied to the deposition zone. As a result, evaporation or similar high-energy physical vapor deposition processes (such as sputtering) are not particularly feasible for fabricating metallized polymer current collectors for battery applications.

Therefore, a need exists for a new battery electrode design and more feasible methods of current collector fabrication whereby metals such as copper and aluminum can be applied in requisite quantities to the surface of polymer films without damaging them, so that the resulting composite metal-polymer substrates may then be employed as lightweight current collectors in lithium-ion batteries.

Thin metal films, when applied to polymer substrates in food packaging applications, are free of defects and pinholes through which moisture and light ingress could occur to inhibit microbial growth. As a result, vacuum evaporation is particularly well-suited as a deposition technique for such films, where highly dense films are achievable due to high surface adatom mobility during the deposition process. In contrast, current collectors for lithium-ion batteries do not require high film density. Instead, current collectors for lithium-ion batteries possess sufficient electrical and thermal conductivity for battery operation. As a result, substantially less-dense and/or porous metal films could feasibly be employed as a current collector for lithium-ion batteries, provided that they possess sufficient electrical conductivity and thermal conductivity.

One way to deposit a thick metal film on a polymer substrate at high rates with minimal heat load is to deposit a film of a colloidal suspension of metal particles (i.e., a metal particle “ink”) onto the polymer substrate via solution-phase thin-film deposition techniques such as slot-die coating or spray coating. The solvents from the ink may then be evaporated, leaving behind a film composed of metal particles. Such metal particle films can be deposited to tens of microns of thickness in a single pass.

Such ink-based approaches for fabricating conductive thin films typically yield films with substantial porosity, but as previously described, porous materials can feasibly be used as current collectors in lithium-ion batteries, provided they possess sufficient electrical conductivity and thermal conductivity.

In some existing techniques, the fabrication of porous metallic films on polymer substrates via solution-phase coating of metal nanoparticle inks is performed, where the use of a porous metal-polymer composite substrate as a current collector is used for lithium metal anodes. In contrast, in implementations described herein, the use of composite substrates as current collectors for a wide variety of battery chemistries is described.

Furthermore, an attribute of an ink-based current collector deposition process is that in certain instances an ink comprising current collector metallic particles can be directly mixed with the active material slurry. The active-material/metal-ink composite slurry can then be cast together onto a substrate such as a polymer film. In various examples, both cathode and anode active materials are first formulated into slurries comprising binders, conductive additives, and solvents, and then cast onto the surface of current collector foils using slot-die deposition to create a battery electrode. Therefore, by mixing the metal ink directly with the electrode active material slurry, both may be applied in a single deposition step onto a given substrate, thereby obviating the need for a separate metal ink deposition step first to form the current collector. This approach is particularly advantageous when the total required metal ink mass fractions are low, relative to active material content, or when the overall total electrode thickness is low (such as for high-energy-density active materials).

An ink-based approach for fabricating a current collector also provides the additional advantage that both the porosity and composition of the final metallic layer can be finely tuned. For example, increasing porosity allows for total metal mass in the current collector to be further minimized, thereby further reducing cell weight, and mechanical properties such as intrinsic stress in the metal layer film may be tuned in porous films in a manner that is impossible with highly dense evaporated thin films. Similarly, a current collector ink, which is primarily composed of a metallic component, may also include other additives, such as binders or conductive additives, that further improve the mechanical and electrical properties of the current collector. Additives such as binders, for example, can improve the flexibility and adhesion of the metal layer, thereby improving the roll-to-roll processability of the composite current collector. In contrast, dense evaporated metal films are composed only of the metal of interest, with limited ability to introduce secondary or tertiary components into the film. Binders can also be introduced to improve the adhesion between the current collector and an active material deposited on top of it.

Another advantage of a porous metal layer within a current collector is that it can accommodate volumetric expansion of active materials during cell operation. Anode active materials such as silicon, for example, are known to expand volumetrically by ˜300% upon full lithiation. To accommodate this expansion, other cell components often contract commensurately. This often results in unwanted pore closing in the microporous separator between anode and cathode, which prevents ion conduction through the electrolyte. By introducing porosity into the current collector, the cell can be designed to preferentially contract in the current collector, where the exclusion of electrolyte does not detrimentally affect cell performance.

Porosity can also be introduced in the underlying polymer substrate in an advantageous manner. Techniques for introducing pores in polymer films with varying pore volume, percentage and diameter are well-established in a number of industries and applications, such as in the polymer membrane and battery separator industries. In the context of a metal-polymer composite current collector, a porous polymer substrate can also be designed to preferentially accommodate the volumetric expansion of active materials, thereby enabling cell designs where total cell thicknesses remain constant during cycling, even when active materials such as silicon are employed.

Finally, during ink-based deposition of metal films on polymer substrates, the underlying polymer experiences much lower heat loads as compared to what would be experienced during vacuum evaporation of a commensurate metal loading. As a result, with ink-based deposition processes, the range of possible compositions of polymer can be greatly expanded to include polymers with low (e.g., glass transition temperatures no greater than 100° C.) glass transition temperatures. Examples include polyethylene, polyethylene glycol, polyester, polyethylene terephthalate, polypropylene, acrylates, polyvinylchloride, etc. Moderate glass transition temperature (e.g., glass transition temperatures of at least 100° C. up to no greater than 200° C.) polymers such as polyimide and aromatic polyamide can also be used.

In some examples, the formation of the metal film may result from the controlled decomposition of reagents within an ink deposited on a polymer substrate. In these implementations, the ink can be composed of a mixture of dissolved chemical reagents (such as solutions of metal salts), instead of a colloidal suspension of pre-formed metal particles. After such an ink is deposited on a polymer substrate, the substrate would then undergo additional thermal and/or chemical treatments in order to decompose the ink into a film composed of porous metal. In some implementations, the ink can include a solution of metal salts as well as metal particles.

The ability to precisely tune the resistivity of the metal layer in a metal-polymer current collector also provides unique safety benefits for the resulting battery, such as a reduction in current density during short circuits. A primary cause of thermal runaway in lithium-ion batteries is an internal short circuit resulting from direct electrical contact between anode and cathode. In such an event, the cell discharges rapidly through the short circuit, which locally increases cell temperature to the point of conflagration. The magnitude of current passing through a short circuit in a lithium-ion battery is directly related to the resistivity of the current collectors: the thicker and more conductive the current collector, the higher the short circuit current. Since copper foils are typically processed to a minimum of 6 microns, they cannot provide a sufficiently high resistance in order to substantially limit current density in a short circuit. By reducing copper thicknesses to less than 6 microns, short circuit current densities can be reduced to the point where they are no longer sufficiently high to raise cell temperatures to the point of thermal runaway. Achieving such low loadings of copper is practically feasible in metal-polymer composite current collectors in contrast with metal foil current collectors.

In the event where a short circuit in a lithium-ion battery is due to the penetration of an external object (such as a nail) through the cell casing, the primary limiter of the short circuit current density becomes the contact resistance between the external object and the current collectors. Here as well, a porous current collector provides fewer contact points between the current collector and an external object as compared to a dense current collector, thereby increasing the contact resistance between the external object and the current collector and reducing short circuit current density.

Furthermore, in the event that a battery is heated to a temperature beyond its recommended safety limit (due to a short circuit or due to abusive external heating, for example), a metal-polymer current collector can have additional built-in safety features to prevent further heating. For example, the metal or polymer layer in a metal-polymer current collector can have an additive material with a high thermal coefficient of expansion (“high T_{c}”), such that when the current collector is heated beyond a certain threshold temperature, the sintered connections within the metal layer can be broken by the rapidly expanding high T_{c} material, thereby mitigating short-circuit currents in the event that a short circuit occurs. Examples of such high Tc materials include polymers, such as polyethylene, polypropylene, polystyrene and polyvinyl chloride. Each of these materials possesses a coefficient of thermal expansion greater than 50×10⁻⁶ K⁻¹. Alternatively, the additive could melt or sublimate at a threshold temperature in a manner that similarly disrupts electrical conduction between metal particles in the metal layer. Low melting point additives include polymers such as ethylene-vinyl acetate, polyvinyl alcohol and polycaprolactone. Each of these materials has a lower melting point than the standard polyethylene/polypropylene separator (less than 100-120° C.), offering the advantage of disrupting the conductive pathways in the current collector before the separator melts and leads to a short circuit between the anode and cathode. Other potential low melting point additives include polymers such as silicone and polyurethane. An example of an additive that sublimates at low temperature is naphthalene, which could similarly disrupt conductive pathways in the current collector during a thermal event. In particular, these additives are more easily introduced into the metal layer when the metal is deposited as an ink, because the additives can be simply mixed into the ink, whereas such materials are likely impossible to introduce into vapor-deposited metals. Such additives are also more easily added to a metal ink than to the base polymer. Another example of a material that can be included as an additive in the metal ink is a fire retardant. Examples of fire-retardant molecules include ammonium polyphosphate, ammonium sulfate or other inorganic molecules such as sodium borate, as well as organic molecules such as melamine and pentaerythritol.

In at least some implementations, in the event of a thermal excursion, the mismatch in melting point and/or T_{c} between the metal and underlying polymer may result in a sufficient film stress to break sintered connections between metal particles, even when no other additives are included in the metal layer. When sintered connections between the metal particles are broken, the cell is in an “open circuit” condition, which prevents any further Joule heating from short-circuit currents.

In at least some examples, the polymer substrate can be pre-treated prior to the deposition of metal or metal-active material inks, in order to improve the adhesion and/or wetting of the inks. Examples of pre-treatment processes include ultraviolet (UV)-Ozone, Corona Discharge, Atmospheric Plasma, or chemical pre-treatments such as rinsing with acidic or basic solutions, or similar primers or etchants.

In one or more examples, the coated metal-polymer or coated metal-active-material-polymer composite can be exposed to a post-deposition treatment (“post-treatment”). Such treatments can be used to help sinter or improve electrical connection between metal particles, for example. Examples include thermal treatments in various ambient environments such as in nitrogen, oxygen, hydrogen, ozone and/or mixtures of these. Non-convective examples include optical flash sintering, spark plasma sintering, ultrasonic sintering, microwave sintering.

In various examples, the adhesion of the metal or metal-active material layer to the underlying polymer substrate can be improved through the deposition of the encapsulating thin film on the surface of the composite. Such encapsulating thin films can be deposited using solution-phase techniques. In at least some examples, the solution-phase techniques used to deposit the encapsulating thin films on the polymeric substrate can include those described in U.S. Pat. No. 10,985,360, which is incorporated by reference herein in its entirety. Such encapsulating films can be primarily inorganic or organic in composition. In one or more examples, the encapsulating thin film can be a composite film comprising inorganic and organic layers. Examples include organic coatings (polyamide, polyimide, polyethylene glycol) and inorganic coatings (metal oxides, metal phosphates, metal sulphates). In at least some examples, during battery operation, the encapsulating thin film can also prevent parasitic electrochemical side reactions from occurring at the metal or metal-active material interface with electrolyte.

The implementations described herein are directed to methods, processes, formulations, techniques, systems, and devices related to the deposition of current collector layers of lithium-ion battery electrodes. The implementations described herein address drawbacks of previously implemented techniques related to the deposition of lithium onto current collector layers, as well as the use of copper and other metals as current collector materials.

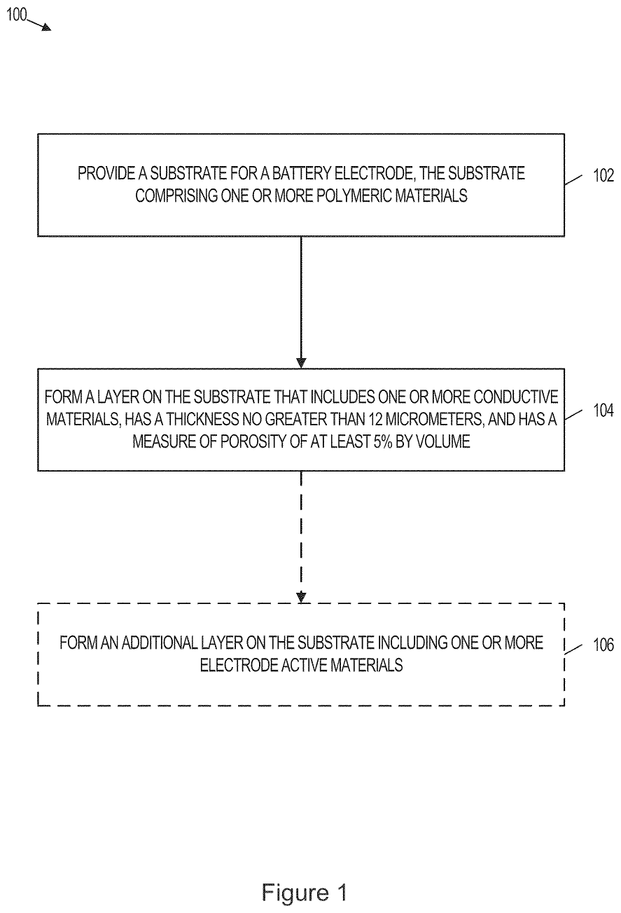

FIG. 1 illustrates a flow diagram of an example process 100 to produce porous current collector layers for lithium-ion batteries, in accordance with one or more examples. The process 100 can include, at operation 102, providing a substrate for a battery electrode, such as a lithium-ion battery electrode. In one or more examples, the substrate can be included in an anode of a lithium-ion battery. Additionally, the substrate can be formed into at least one of a sheet or foil. In at least some examples, the substrate can be configured for processing using a roll-to-roll conveyance apparatus.

In one or more examples, substrate can comprise one or more polymeric materials. In various examples, the one or more polymeric materials can have a glass transition temperature no greater than 50° C., no greater than 80° C., no greater than 100° C., no greater than 120° C., no greater than 150° C., no greater than 180° C., no greater than about 200° C., no greater than about 210° C., no greater than about 220° C., no greater than about 230° C., no greater than about 240° C., no greater than about 250° C., no greater than about 260° C., no greater than about 270°C., no greater than about 280° C., no greater than about 290° C., no greater than about 300° C., no greater than about 325° C., or no greater than about 350° C. For example, the one or more polymeric materials can have a glass transition temperature from about 50° C. to about 350° C., from about 80° C. to about 250° C., from about 100° C. to about 200° C., from about 200° C. to about 300° C., from about 200° C. to about 240° C., from about 260° C. to about 300° C., or from about 230° C. to about 270° C. In one or more illustrative examples, the one or more polymeric materials can include at least one of a polyethylene, a polyethylene glycol, a polypropylene, a polyimide, a polyether ether ketone, a polyester, polyethylene terephthalate, a polyamide, a polyvinylchloride, a polyacrylate, or a polyethylene naphthalate.

In at least some examples, the substrate can have a measure of porosity. To illustrate, the substrate can include at least about 5% by volume pores, at least about 10% by volume pores, at least about 15% by volume pores, at least about 20% by volume pores, or at least about 25% by volume pores. Additionally, the substrate can include no greater than about 65% by volume pores, no greater than about 60% by volume pores, no greater than about 55% by volume pores, no greater than about 50% by volume pores, no greater than about 45% by volume pores, or no greater than about 40% by volume pores. In one or more illustrative examples, the substrate can have from about 5% by volume pores to about 65% by volume pores, from about 5% by volume pores to about 60% by volume pores, from about 10% by volume pores to about 55% by volume pores, from about 15% by volume pores to about 50% by volume pores, or from about 20% by volume pores to about 45% by volume pores. In various examples, the pores can have a spherical shape. In addition, the pores can have a d₅₀ from about 1 nanometer (nm) to about 500 nm, from about 10 nm to about 400 nm, from about 50 nm to about 250 nm, from about 100 nm to about 200 nm, from about 200 nm to about 400 nm, or from about 1 nm to about 100 nm.

Prior to performing additional process operations, one or more surfaces of the substrate can be pretreated. For example, the substrate can be subjected to one or more pretreatment operations that can improve adhesion of one or more substances deposited on the substrate. Additionally, the one or more pretreatment operations can improve wetting of one or more substances deposited on the substrate. In one or more examples, the substrate can be subjected to one or more pretreatment operations that can improve at least one of adhesion or wetting of one or more inks deposited on the substrate. In one or more illustrative examples, one or more pretreatment processes applied to the substrate can include a ultraviolet (UV)-ozone treatment that includes exposing the substrate to an ozone producing UV source. In one or more additional illustrative examples, the one or more pretreatment processes applied to the substrate can include a corona discharge. In one or more further illustrative examples, the one or more pretreatment processes can include an atmospheric plasma treatment. In still other illustrative examples, the one or more pretreatment processes can include one or more chemical pre-treatments, such as rinsing one or more surfaces of the substrate with one or more solutions. In at least some examples, the one or more solutions can include at least one of acidic solutions, basic solutions, primers, or etchants. In various examples, the one or more pretreatment processes can be conducted in an environment having a temperature from about 15° C. to about 35° C. and pressures from about 95 kilopascals (kPa) to about 110 kPa.

At operation 104, the process 100 can include forming a layer on the substrate that includes one or more conductive materials. In various examples, the one or more conductive materials can include at least one of copper, alloys of copper, aluminum, alloys of aluminum, titanium, alloys of titanium, nickel, alloys of nickel, or stainless steel. Additionally, the one or more conductive materials can be comprised of particles having a spherical morphology. In these situations, the layer can include particles having a d₅₀ from about 10 nm to about 100 nm, from about 10 nm to about 50 nm, from about 20 nm to about 60 nm, from about 30 nm to about 70 nm, from about 40 nm to about 80 nm, or from about 50 nm to about 90 nm. Further, the one or more conductive materials can be comprised of particles having a nanowire morphology. In one or more illustrative examples, particles of the one or more conductive materials having the nanowire morphology can have lengths from about 1 micrometer to about 100 micrometers, from about 5 micrometers to about 50 micrometers, from about 10 micrometers to about 40 micrometers, from about 30 micrometers to about 70 micrometers, or from about 60 micrometers to about 100 micrometers. Further, particles of the one or more conductive materials having the nanowire morphology can have diameters from about 10 nm to about 200 nm, from about 20 nm to about 150 nm, from about 30 nm to about 100 nm, from about 20 nm to about 50 nm, from about 50 nm to about 100 nm, or from about 75 nm to about 150 nm.

In addition, the layer can have a thickness that is no greater than about 20 micrometers, no greater than about 18 micrometers, no greater than about 15 micrometers, no greater than about 10 micrometers, no greater than about 8 micrometers, or no greater than about 5 micrometers. In one or more illustrative examples, the layer can have a thickness that is from about 1 micrometer to about 20 micrometers, from about 2 micrometers to about 18 micrometers, from about 3 micrometers to about 15 micrometers, from about 2 micrometers to about 10 micrometers, from about 5 micrometers to about 12 micrometers, or from about 10 micrometers to about 20 micrometers.

Further, the layer can have a measure of porosity of at least about 5% by volume, at least about 10% by volume, at least about 15% by volume, at least about 20% by volume, at least about 25% by volume, at least about 30% by volume, at least about 35% by volume, at least about 40% by volume, at least about 45% by volume, or at least about 50% by volume. In various examples, the layer can include from about 5% by volume pores to about 60% by volume pores, from about 10% by volume pores to about 50% by volume pores, from about 15% by volume pores to about 40% by volume pores, from about 5% by volume pores to about 30% by volume pores, from about 30% by volume pores to about 60% by volume pores, or from about 25% by volume pores to about 50% by volume pores. In one or more examples, pores of the layer can have diameters no greater than 25 nm, no greater than 20 nm, no greater than 15 nm, no greater than 10 nm, or no greater than 5 nm. In one or more illustrative examples, pores of the layer can have diameters from about 0.5 nm to about 25 nm, from about 1 nm to about 20 nm, from about 2 nm to about 15 nm, from about 5 nm to about 20 nm, from about 1 nm to about 10 nm, or from about 10 nm to about 20 nm.

The layer can be formed on the substrate by performing one or more solution-phase coating processes. In one or more examples, the layer can be formed on the substrate by performing at least one of a slot-die process, a spray process, an aerosol process, a bath process, a gravure coating process, a comma coating process, or a dip coating process. In one or more illustrative examples, the layer can be formed on the substrate by depositing a formulation on the substrate that is characterized as an ink. The ink can include first particles comprised of the one or more conductive materials and one or more solvents. The one or more solvents can include one or more organic solvents. In various examples, the one or more solvents can include at least one of isopropyl alcohol, ethanol, methanol, tert-butanol, 1-butanol, 2-Amino-2-methyl-1-propanol, amino-2-propanol, 2-methoxyethanol, ethylene glycol, dipropylene glycol monomethyl ether, diethylene glycol methyl ether, benzyl alcohol, pyridine, tetrahydrofuran (THF), hexane, toluene, or water.

In at least some examples, one or more thermal treatments can be performed after depositing an ink on the substrate. The one or more thermal treatments can be performed at temperatures no greater than about 325° C., no greater than about 300° C., no greater than about 275° C., no greater than about 250° C., or no greater than about 225° C. For example, the one or more thermal treatments can be performed at temperatures from about 75° C. to about 325°C., from about 100° C. to about 200° C., from about 150° C. to about 250° C., or from about 200° C. to about 300° C. In various examples, the one or more thermal treatments can be performed in an environment that includes one or more gases comprised of at least one of nitrogen, oxygen, hydrogen, ozone, or argon. In one or more illustrative examples, the one or more gases can be ionized.

In one or more examples, the layer can include one or more additional components that can be part of a battery electrode. For example, the layer can also include one or more electrode active materials. In various examples, the one or more electrode active materials can correspond to materials used in anodes of lithium-ion batteries. In one or more illustrative examples, the one or more electrode active materials can comprise at least one of graphite, Si, Sn, Ge, Al, P, Zn, Ga, As, Cd, In, Sb, Pb, Bi, SiO, SnO₂, Si, Sn, lithium metal, LiNiₓMn_{y}Co_{z}O₂, LiNiₓCo_{y}Al_{z}O₂, LiMnₓNi_{y}O_{z}, LiMnO₂, LiFePO₄, LiMnPO₄, LiNiPO₄, LiCoPO₄, LiV₂O₅, sulfur, or LiCoO₂ where x, y and z are stoichiometric coefficients. Additionally, the layer can include one or more binding materials to cause the one or more electrode active materials to bind with the one or more conductive materials. The one or more binding materials can include at least one of a polyvinylidene fluoride, a polyamide imide, a polyethylene oxide, a polyimide, a poly (acrylic acid), a poly (methyl methacrylate), a polyvinyl alcohol, or a polypropylene carbonate. Further, the layer can include one or more conductive additives comprising at least one of carbon black particles, carbon nanotubes, or graphite particles. In scenarios where the layer includes one or more additional components, an ink used to form the layer can include the first particles comprising the one or more conductive materials in addition to at least one of second particles that correspond to the one or more electrode active materials, third particles that correspond to the one or more binding materials, or fourth particles that correspond to the one or more conductive additives. In this way, current collector materials and electrode active materials can be combined in a single layer that is formed on a polymeric substrate.

Optionally, the process 100 can include, at operation 106, forming an additional layer on the substrate, where the additional layer includes one or more electrode active materials. In these implementations, the initial layer formed on the substrate that includes the one or more conductive materials can include a current collector layer and the additional layer can comprise an electrode active material layer. The active material layer can include one or more electrode active materials and, optionally, at least one of one or more binding materials or one or more conductive materials similar to or the same as those described previously in relation to the combined current collector and active material layer. To illustrate, the additional layer can include one or more electrode active materials that correspond to an anode of a lithium-ion battery and comprise at least one of graphite, Si, Sn, Ge, Al, P, Zn, Ga, As, Cd, In, Sb, Pb, Bi, SiO, SnO₂, Si, Sn, lithium metal, LiNiₓMn_{y}Co_{z}O₂, LiNiₓCo_{y}Al_{z}O₂, LiMnₓNi_{y}O_{z}, LiMnO₂, LiFePO₄, LiMnPO₄, LiNiPO₄, LiCoPO₄, LiV₂O₅, sulfur, or LiCoO₂ where x, y and z are stoichiometric coefficients. Further, the active material layer can include at least one of one or more binding materials that include at least one of a polyvinylidene fluoride, a polyamide imide, a polyethylene oxide, a polyimide, a poly (acrylic acid), a poly (methyl methacrylate), a polyvinyl alcohol, or a polypropylene carbonate or one or more conductive additives that include at least one of carbon black particles, carbon nanotubes, or graphite particles.

In one or more examples, the active material layer can be formed on the current collector layer by performing an additional solution-phase coating process that includes at least one of a slot-die process, a spray process, an aerosol process, a bath process, a gravure coating process, a comma coating process, or a dip coating process. In various examples, the active material layer can be formed on the current collector layer by depositing an additional ink on the current collector layer. The additional ink can include one or more solvents and particles that comprise the one or more electrode active materials, particles that comprise the one or more binding materials, and/or particles that comprise the one or more conductive additives. The one or more solvents can include at least one of isopropyl alcohol, ethanol, methanol, tert-butanol, 1-butanol, 2-Amino-2-methyl-1-propanol, amino-2-propanol, 2-methoxyethanol, ethylene glycol, dipropylene glycol monomethyl ether, diethylene glycol methyl ether, n-methyl pyrrolidone, benzyl alcohol, pyridine, tetrahydrofuran (THF), hexane, toluene, or water. In one or more illustrative examples, active material binders can include at least one of PVDF, polyacrylic acid, carboxymethylcellulose or styrene butadiene rubber. In one or more additional illustrative examples, active material conductive additives include at least one of carbon black or carbon nanotubes. The deposition of the additional ink on the current collector layer can be followed by one or more thermal treatments that are performed at temperatures no greater than about 325° C., no greater than about 300° C., no greater than about 275° C., no greater than about 250° C., or no greater than about 225° C. Additionally, the one or more additional thermal treatments can be performed in an environment that includes one or more gases that can be ionized. In one or more illustrative examples, the one or more gases can include at least one of nitrogen, oxygen, hydrogen, or argon.

Additionally, an encapsulating thin film can be deposited on at least one of the one or more conductive materials or a composite conductive material-active material complex that includes one or more conductive materials and one or more electrode active materials. The encapsulating thin film can improve adhesion of at least one of conductive particles, active material particles, or conductive particle-active material complexes to the substrate. In one or more examples, the encapsulating thin film can include at least one of one or more organic materials or one or more inorganic materials. In one or more additional examples, the encapsulating thin film can include a composite film including a number of layers including one or more first layers including one or more organic materials and one or more second layers including one or more inorganic materials. In at least some examples, the encapsulating thin film can include alternating layers of organic materials and inorganic materials. In one or more illustrative examples, the encapsulating thin film can include a polyamide, a polyimide, polyethylene glycol, one or more metal oxides, one or more metal phosphates, one or more metal sulphates, one or more metalcones, or one or more combinations thereof. In various examples, the encapsulating thin film can reduce or prevent electrochemical side reactions from taking place between conductive materials and/or conductive material-active material complexes and an electrolyte present in a battery. The encapsulating thin film can have thicknesses from about 1 nm to about 1000 nm, from about 10 nm to about 500 nm, from about 50 nm to about 250 nm, from about 10 nm to about 100 nm, or from about 100 nm to about 500 nm.

In at least some examples, the encapsulating thin film can be formed using one or more solution-phase techniques. For example, the encapsulating thin film can be formed by exposing at least one of one or more conductive materials or a conductive material-active material complex formed on the substrate to one or more solutions. To illustrate, the encapsulating thin film can be formed by at least one of submerging, spraying, slot die coating, bath coating, or gravure roller coating. In one or more illustrative examples, the encapsulating thin film can be formed using a roll-to-roll conveyance apparatus that immerses the substrate having one or more layers comprising at least one of one or more conductive materials or one or more conductive material-active material complexes in one or more reaction chambers. In various examples, the polymeric substrate can be formed in a continuous or semi-continuous sheet. After forming one or more layers including at least one of one or more conductive materials or one or more conductive material-active material complexes, a conveyance apparatus can transport the sheet into one or more reaction chambers that comprise one or more solutions that include at least a portion of the components of the encapsulating thin film. In one or more examples, the conveyance apparatus can cause the substrate with the one or more conductive materials or conductive material-active material complexes deposited thereon to be submerged into a number of reaction chambers where one or more layers of the encapsulating thin film are formed in individual reaction chambers.

In various examples, after one or more layers have been deposited on the substrate, one or more post-deposition treatments can be performed. For example, one or more post-deposition treatments can be performed after a layer including the one or more conductive materials has been deposited on the substrate. In one or more additional examples, one or more post-deposition treatments can be performed after one or more composite metal-active material layers have been formed on the substrate. In at least some examples, the one or more post-deposition treatments can improve electrical connections between conductive particles that have been deposited on the substrate. To illustrate, the one or more post-deposition treatments can cause and/or increase sintering between metallic particles deposited on the substrate. In one or more examples, the one or more post-deposition treatments can include one or more thermal treatments. In one or more illustrative examples, the one or more post-deposition treatments can include at least one of optical flash sintering, spark plasma sintering, ultrasonic sintering, or microwave sintering.

Further, at least one of the layer deposited in operation 104 or the additional layer deposited in operation 106 can include additives that provide battery safety features. For example, at least one of the layer or the additional layer can include one or more fire retardants, and/or one or more thermal management additives that can reduce or prevent excess heating of lithium-ion batteries. In one or more illustrative examples, at least one of the layer or the additional layer can include one or more fire retardant additives selected from at least one of ammonium polyphosphate, ammonium sulfate, other inorganic molecules such as sodium borate, or organic molecules, such as melamine and pentaerythritol. In one or more additional illustrative examples, at least one of the layer or the additional layer can include one or more first thermal management additives having a coefficient of thermal expansion of at least 30×10⁻⁶ K⁻¹, at least 40×10⁻⁶ K⁻¹, at least 50×10⁻⁶ K⁻¹, at least 60×10⁻⁶ K⁻¹, at least 70×10⁻⁶ K⁻¹, at least 80×10⁻⁶ K⁻¹, at least 90×10⁻⁶ K⁻¹, or at least 100×10⁻⁶ K⁻¹. In various examples, at least one of the layer or the additional layer can include one or more first thermal management additives comprised of one or more polymeric materials. To illustrate, at least one of the layer or the additional layer can include at least one of a polyethylene, a polypropylene, a polystyrene, a polyethylene terephthalate, a polytetrafluoroethylene, a polycarbonate, or a polyvinyl chloride.

At least one of the layer or the additional layer can include one or more second thermal management additives having melting points no greater than 130° C., no greater than 120° C., no greater than 110° C., no greater than 100° C., or no greater than 90° C. In various examples, the one or more second thermal management additives can disrupt conductive pathways in a current collector of a lithium-ion battery. For example, at least one of the layer or the additional layer can include one or more second thermal management additives comprised of one or more polymeric materials or foams having a melting point that is less than a melting point of polyethylene, polypropylene, or a combination thereof. To illustrate, at least one of the layer or the additional layer can include one or more second thermal management additives comprised of at least one of an ethylene-vinyl acetate, a polyvinyl alcohol, a polycaprolactone, silicone, or a polyurethane. The one or more second thermal management additives can also include one or more materials that sublimate at temperatures no greater than 130° C., no greater than 120° C., no greater than 110° C., no greater than 100° C., or no greater than 90° C. In one or more further illustrative examples, the one or more second thermal management additives can include naphthalene.

By forming a porous current collector layer or a porous layer that combines current collector particles and electrode active material particles, lithium-ion batteries can be produced that have advantages with respect to existing lithium-ion batteries. For example, lithium-ion batteries described herein can have an increased gravimetric energy density with respect to existing lithium-ion batteries by reducing the amount of copper present in a current collector layer, while providing sufficient electrical conductivity to facilitate the transport of lithium ions between electrodes of the lithium-ion batteries. Additionally, the porosity of at least one of the current collector layer or the combined current collector layer and electrode active material layer can reduce the impact of expansion of active materials that takes place during usage of the lithium-ion batteries. That is, the increased porosity of current collector layers and/or electrode active materials of lithium-ion batteries described herein can enable increased transport of lithium ions between electrodes with respect to existing lithium-ion batteries that have more restricted transport of lithium-ions due to the expansion of electrode active materials.

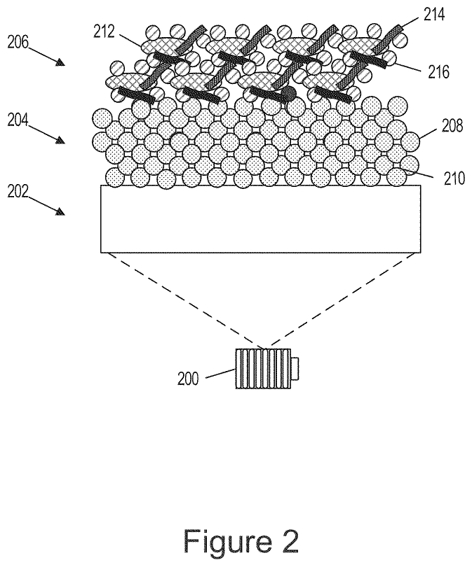

FIG. 2 illustrates a device 200 that includes a substrate 202, a porous current collector layer 204, and an electrode active material layer 206 disposed on the current collector layer 204 comprised of spherical conductive particles 208, in accordance with one or more examples. In one or more examples, the device 200 can include a lithium-ion battery. Additionally, the substrate 202 can include at least one of a sheet or foil that is comprised of one or more polymeric materials that include at least one of a polyethylene, a polyethylene glycol, a polypropylene, a polyimide, a polyether ether ketone, a polyester, polyethylene terephthalate, a polyamide, a polyvinylchloride, a polyacrylate, or a polyethylene naphthalate. Further, the spherical conductive particles 208 can comprise at least one of copper, aluminum, titanium, nickel, or stainless steel. The current collector layer 204 can have pores 210 comprising at least 5% by volume of the current collector layer 204.

The electrode active material layer 206 can include anode active material particles 212, binding material particles 214, and conductive additive particles 216. The anode active material particles 212 can comprise at least one of graphite, Si, Sn, Ge, Al, P, Zn, Ga, As, Cd, In, Sb, Pb, Bi, SiO, SnO₂, Si, Sn, lithium metal, LiNiₓMn_{y}Co_{z}O₂, LiNiₓCo_{y}Al_{z}O₂, LiMnₓNi_{y}O_{z}, LiMnO₂, LiFePO₄, LiMnPO₄, LiNiPO₄, LiCoPO₄, LiV₂O₅, sulfur, or LiCoO₂ where x, y and z are stoichiometric coefficients. The binding material particles 214 can comprise at least one of a polyvinylidene fluoride, a polyamide imide, a polyethylene oxide, a polyimide, a poly (acrylic acid), a poly (methyl methacrylate), a polyvinyl alcohol, or a polypropylene carbonate and the conductive additive particles 216 can comprise at least one of carbon black particles, carbon nanotubes, or graphite particles.

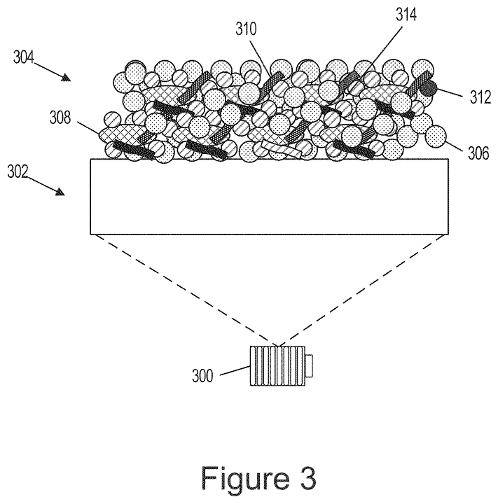

FIG. 3 illustrates a device 300 that includes a substrate 302 and a layer 304 comprised of spherical conductive particles 306 and electrode active material particles 308, in accordance with one or more examples. In one or more examples, the device 300 can include a lithium-ion battery. Additionally, the substrate 302 can include at least one of a sheet or foil that is comprised of one or more polymeric materials that include at least one of a polyethylene, a polyethylene glycol, a polypropylene, a polyimide, a polyether ether ketone, a polyester, polyethylene terephthalate, a polyamide, a polyvinylchloride, a polyacrylate, or a polyethylene naphthalate.

The layer 304 can be a combined current collector and electrode active material layer. The spherical conductive particles 306 can comprise at least one of copper, aluminum, titanium, nickel, or stainless steel. In addition, the electrode active material particles 308 can comprise at least one of graphite, Si, Sn, Ge, Al, P, Zn, Ga, As, Cd, In, Sb, Pb, Bi, SiO, SnO₂, Si, Sn, lithium metal, LiNiₓMn_{y}Co_{z}O₂, LiNiₓCo_{y}Al_{z}O₂, LiMnₓNi_{y}O_{z}, LiMnO₂, LiFePO₄, LiMnPO₄, LiNiPO₄, LiCoPO₄, LiV₂O₅, sulfur, or LiCoO₂ where x, y and z are stoichiometric coefficients. The layer 304 can also include binding material particles 310 that can comprise at least one of a polyvinylidene fluoride, a polyamide imide, a polyethylene oxide, a polyimide, a poly (acrylic acid), a poly (methyl methacrylate), a polyvinyl alcohol, or a polypropylene carbonate and conductive additive particles 312 that can comprise at least one of carbon black particles, carbon nanotubes, or graphite particles. In various examples, the layer 304 can have pores 314 comprising at least 5% by volume of the layer 304.

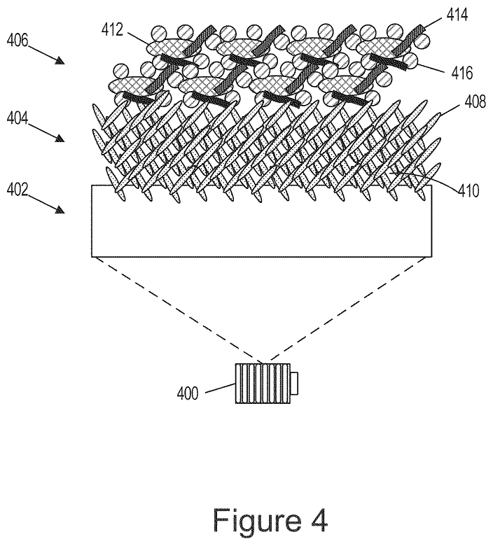

FIG. 4 illustrates a device 400 that includes a substrate 402, a porous current collector layer 404, and an electrode active material layer 406 disposed on the current collector layer 404 comprised of conductive nanowires 408, in accordance with one or more examples. In one or more examples, the device 400 can include a lithium-ion battery. Additionally, the substrate 402 can include at least one of a sheet or foil that is comprised of one or more polymeric materials that include at least one of a polyethylene, a polyethylene glycol, a polypropylene, a polyimide, a polyether ether ketone, a polyester, polyethylene terephthalate, a polyamide, a polyvinylchloride, a polyacrylate, or a polyethylene naphthalate. Further, the conductive nanowires 408 can comprise at least one of copper, aluminum, titanium, nickel, or stainless steel. The current collector layer 404 can have pores 410 comprising at least 5% by volume of the current collector layer 404.

The electrode active material layer 406 can include anode active material particles 412, binding material particles 414, and conductive additive particles 416. The anode active material particles 412 can comprise at least one of graphite, Si, Sn, Ge, Al, P, Zn, Ga, As, Cd, In, Sb, Pb, Bi, SiO, SnO₂, Si, Sn, lithium metal, LiNiₓMn_{y}Co_{z}O₂, LiNiₓCo_{y}Al_{z}O₂, LiMnₓNi_{y}O_{z}, LiMnO₂, LiFePO₄, LiMnPO₄, LiNiPO₄, LiCoPO₄, LiV₂O₅, sulfur, or LiCoO₂ where x, y and z are stoichiometric coefficients. The binding material particles 414 can comprise at least one of polyvinylidene fluoride, a polyamide imide, a polyethylene oxide, a polyimide, a poly (acrylic acid), a poly (methyl methacrylate), a polyvinyl alcohol, or a polypropylene carbonate and the conductive additive particles 416 can comprise at least one of carbon black particles, carbon nanotubes, or graphite particles.

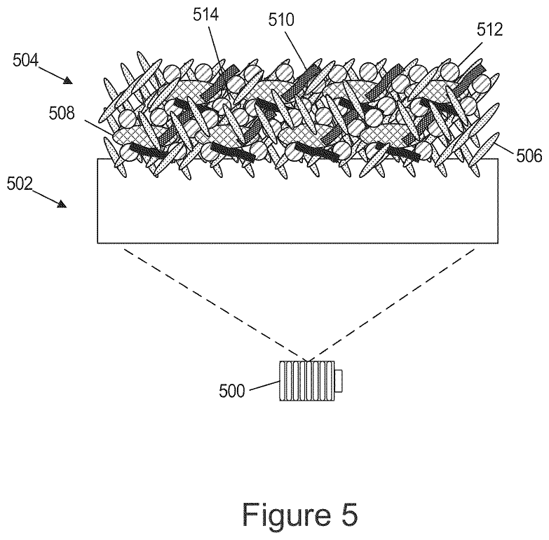

FIG. 5 illustrates a device 500 that includes a substrate 502 and a layer 504 comprised of conductive nanowires 506 and electrode active material particles 508, in accordance with one or more examples. In one or more examples, the device 500 can include a lithium-ion battery. Additionally, the substrate 502 can include at least one of a sheet or foil that is comprised of one or more polymeric materials that include at least one of a polyethylene, a polyethylene glycol, a polypropylene, a polyimide, a polyether ether ketone, a polyester, polyethylene terephthalate, a polyamide, a polyvinylchloride, a polyacrylate, or a polyethylene naphthalate.

The layer 504 can be a combined current collector and electrode active material layer. The conductive nanowires 506 can comprise at least one of copper, aluminum, titanium, nickel, or stainless steel. In addition, the electrode active material particles 508 can comprise at least one of graphite, Si, Sn, Ge, Al, P, Zn, Ga, As, Cd, In, Sb, Pb, Bi, SiO, SnO₂, Si, Sn, lithium metal, LiNiₓMn_{y}Co_{z}O₂, LiNiₓCo_{y}Al_{z}O₂, LiMnₓNi_{y}O_{z}, LiMnO₂, LiFePO₄, LiMnPO₄, LiNiPO₄, LiCoPO₄, LiV₂O₅, sulfur, or LiCoO₂ where x, y and z are stoichiometric coefficients. The layer 504 can also include binding material particles 510 that can comprise at least one of a polyvinylidene fluoride, a polyamide imide, a polyethylene oxide, a polyimide, a poly (acrylic acid), a poly (methyl methacrylate), a polyvinyl alcohol, or a polypropylene carbonate and conductive additive particles 512 that can comprise at least one of carbon black particles, carbon nanotubes, or graphite particles. In various examples, the layer 504 can have pores 514 comprising at least 5% by volume of the layer 504.

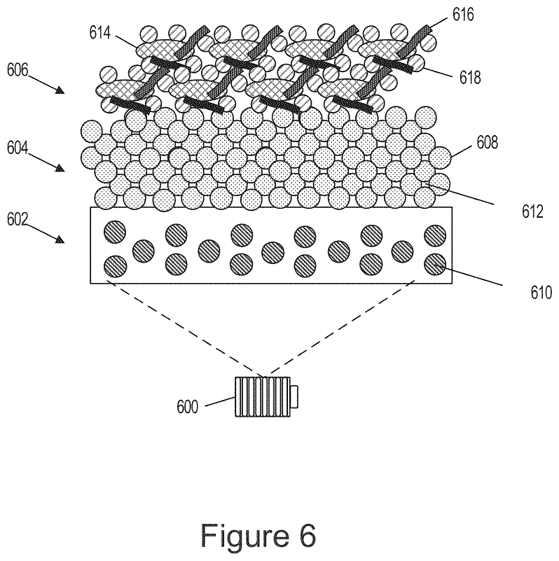

FIG. 6 illustrates a device 600 that includes a porous substrate 602, a porous current collector layer 604, and an electrode active material layer 606 disposed on the current collector layer 604 comprised of spherical conductive particles 608, in accordance with one or more examples. In one or more examples, the device 600 can include a lithium-ion battery. Additionally, the substrate 602 can include at least one of a sheet or foil that is comprised of one or more polymeric materials that include at least one of a polyethylene, a polyethylene glycol, a polypropylene, a polyimide, a polyether ether ketone, a polyester, polyethylene terephthalate, a polyamide, a polyvinylchloride, a polyacrylate, or a polyethylene naphthalate. In various examples, the substrate 602 can have pores 610 comprising at least 5% by volume of the substrate 602. Further, the spherical conductive particles 608 can comprise at least one of copper, aluminum, titanium, nickel, or stainless steel. The current collector layer 604 can have pores 612 comprising at least 5% by volume of the current collector layer 604.

The electrode active material layer 606 can include anode active material particles 614, binding material particles 616, and conductive additive particles 618. The anode active material particles 614 can comprise at least one of graphite, Si, Sn, Ge, Al, P, Zn, Ga, As, Cd, In, Sb, Pb, Bi, SiO, SnO₂, Si, Sn, lithium metal, LiNiₓMn_{y}Co_{z}O₂, LiNiₓCo_{y}Al_{z}O₂, LiMnₓNi_{y}O_{z}, LiMnO₂, LiFePO₄, LiMnPO₄, LiNiPO₄, LiCoPO₄, LiV₂O₅, sulfur, or LiCoO₂ where x, y and z are stoichiometric coefficients. The binding material particles 616 can comprise at least one of polyvinylidene fluoride, a polyamide imide, a polyethylene oxide, a polyimide, a poly (acrylic acid), a poly (methyl methacrylate), a polyvinyl alcohol, or a polypropylene carbonate and the conductive additive particles 618 can comprise at least one of carbon black particles, carbon nanotubes, or graphite particles.

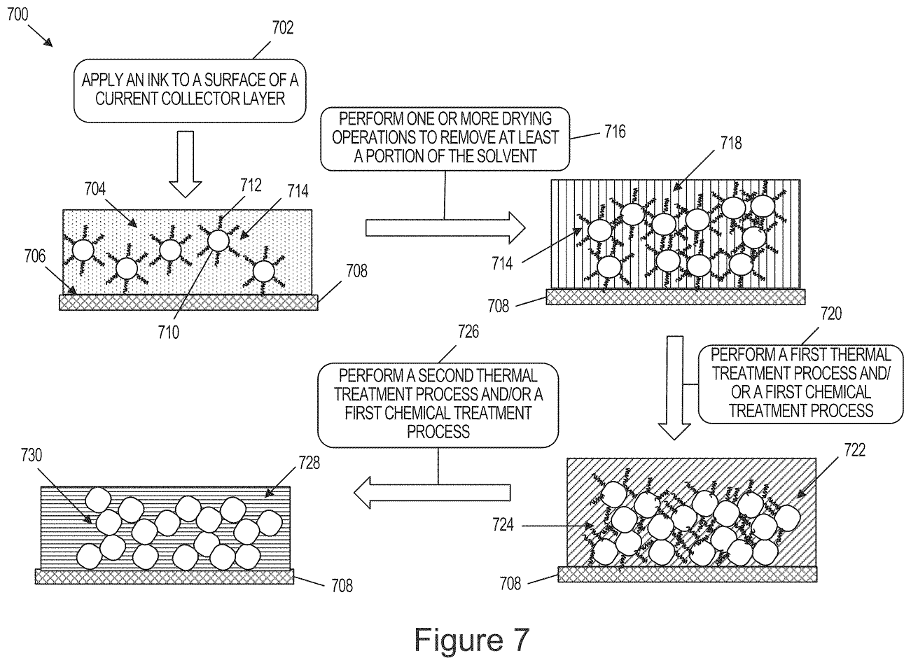

FIG. 7 is a diagram of a process 700 to produce a nanoparticle seed layer on a surface of a current collector layer. The process 700 can include an operation 702 of applying an ink 704 to a surface 706 of a current collector layer 708. In one or more illustrative examples, the ink 704 can be applied to the surface 706 of the current collector layer 708 via a solution-phase thin film coating process. In one or more illustrative examples, the solution-phase coating process can include at least one of a slot-die coating process, a spray coating process, an aerosol coating process, a bath coating process, a gravure coating process, a comma coating process, or a dip coating process. The current collector layer 708 can comprise a metallic material. For example, the current collector layer 708 can comprise at least one of copper, alloys of copper, titanium, alloys of titanium, nickel, alloys of nickel, or a stainless steel. In one or more additional examples, the current collector layer 708 can comprise one or more polymeric materials. In various examples, the current collector layer 708 can comprise at least one of a polyethylene, a polypropylene, a polyimide, a polyether ether ketone, a polyester, a polyamide, or a polyethylene napthalate. In one or more further examples, the current collector layer 708 can be composed solely of one or more polymeric materials. In still other examples, the current collector layer 708 can include one or more of the polymeric materials overlaid with one or more of the metallic materials. In one or more illustrative examples, the current collector layer 708 can comprise a foil.

The ink 704 can include a number of nanoparticles 710. One or more ligands 712 can be coupled to individual nanoparticles 710. The individual combinations of nanoparticles 710 with the one or more ligands 712 can result in ligand-functionalized nanoparticles 714 disposed within the ink 704. The ink 704 can also comprise a solvent in which the nanoparticles 710 are dispersed. In one or more examples, the ink 704 can be applied on both sides of the current collector layer 708. In one or more additional examples, the ink 704 can be applied to one side of the current collector layer 708. In at least some examples, the ink 704 can include one or more conductive materials and one or more polymeric materials. The one or more conductive materials can include one or more metallic materials. The one or more polymeric materials can provide adhesive properties and/or cohesion properties for the ink 704.

Critical design parameters for the ink 704 can include nanoparticle material, size, and geometry, as well as composition and size of the nanoparticle surface-functionalizing ligand. In addition, solids content of the nanoparticles 710 and associated ligands 712 within the ink 704 is a critical variable. Size of the nanoparticles 710, for instance, can vary from 0.5 nanometers (nm) to 500 nm, from 0.5 nm to 100 nm, from 100 nm to 250 nm, from 50 nm to 300 nm, from 250 nm to 500 nm, from 200 nm to 400 nm, or from 300 nm to 500 nm in diameter in the case of spherical nanoparticles. Size of the ligands 712 can be characterized in terms of molecular weight, ranging, for example, from 20 Da to 10 kDa, from 10 Da to 1 kDa, from 100 Da to 500 Da, from 500 Da to 1500 Da, from 1 kDa to 10 kDa, from 5 kDa to 10 kDa, from 1 kDa to 5 kDa, from 2 kDa to 6 kDa, from 3 kDa to 7 kDa, or from 4 kDa to 8 kDa. Solids content of the ink 704 can range from 1% to 90%, for instance, where solids content is defined as the sum of the mass of nanoparticles 710 and ligands 712 divided by solvent mass. In one or more illustrative examples, the solids content can be from 1% to 10%, from 5% to 20%, from 15% to 30%, from 25% to 40%, from 30% to 50%, from 40% to 60%, from 50% to 70%, from 60% to 80%, from 70% to 90%, from 85% to 95%, or from 90% to 99%.

In one or more examples, the ligands 712 can act as an ion conductor, and therefore may not need to be removed from the “dry” film by a technique such as combustion or dissolution, because it provides ionic conductivity in the manner of an electrolyte. In various examples, the ligands 712 can include a molecule having a chelating group that aids in dispersion of the nanoparticles 710 in a solvent of the ink 704.

The nanoparticles 710 can include one or more metallic materials. The one or more metallic materials can have a bulk resistivity of 1×10⁻¹² Ohm-cm to 1 Ohm-cm. In addition, the nanoparticles 710 can include one or more semiconducting materials. The one or more semiconducting materials can have a bulk resistivity of 1 Ohm-cm to 1000 Ohm-cm. In one or more further examples, the nanoparticles 710 can include one or more insulating materials. The one or more insulating materials can have a bulk resistivity of 1000 Ohm-cm to 1×10¹³ Ohm-cm. In one or more illustrative examples, the bulk resistivity can be determined at temperatures from 20° C. to 30° C. In various examples, the nanoparticles 710 may not be intrinsically metallic, but may be semiconducting or even electrically insulating in nature. In one or more illustrative examples, the nanoparticles 710 can be characterized as sufficiently electrically conductive to avoid introducing an excessive direct current (DC) internal resistance during operation of a battery comprising the nanoparticles 710. The absence of excessive DC current can take place despite the nanoparticles 710 being semiconducting or insulating. In one or more examples, a battery in which the nanoparticles 710 are located may rely on the electrical conductivity of a Li metal layer of the battery to ensure good power capability rather than relying on the conductivity of the nanoparticles 710. Semiconducting or insulating nanoparticles 710 can also be modified to have metallic properties through a subsequent thermal and/or chemical treatment performed on a final seed layer of the nanoparticles 710 or through coating with a very thin layer of metal. In various examples, the nanoparticles 710 can be rendered electrically conductive by electroless plating with one or more metals.

In one or more examples, two different compositions of nanoparticles 710 can constitute the seed layer. For example, first nanoparticles having a first composition can be used to provide structural integrity to the seed layer, while second nanoparticles having a second composition can be used to provide sites for catalyzed and controlled nucleation of Li metal. In one or more illustrative examples, the nanoparticles 710 can be a “core-shell” type of nanoparticle, wherein the nanoparticles 710 can include two different materials. To illustrate, the nanoparticles 710 can include an inner core comprised of one or more first materials, and an outer shell disposed around the core comprised of one or more second materials. In these scenarios, the core can provide structural integrity to the seed layer, while the shell can provide sites for catalyzed and controlled nucleation of Li metal. In one or more additional examples, the nanoparticles 710 can have a spherical geometry. To illustrate, the nanoparticles 710 can have a multi-faceted polyhedral geometry.

The nanoparticles 710 can have a dimension from 1 Angstrom to 100 nm, from 100 Angstroms to 100 nm, from 100 Angstroms to 1 nm, from 1 nm to 100 nm, from 10 nm to 100 nm, from 10 nm to 50 nm, or from 50 nm to 100 nm. In situations where the nanoparticles 710 have a spherical geometry, the nanoparticles 710 can have a diameter from 1 Angstrom to 100 nm, from 100 Angstroms to 100 nm, from 100 Angstroms to 1 nm, from 1 nm to 100 nm, from 10 nm to 100 nm, from 10 nm to 50 nm, or from 50 nm to 100 nm.

The ink 704 can also include a number of additives. The additives can include one or more organic molecules. For example, the additives can be included in the ink 704 to further modify the porosity and packing density of the nanoparticles 710 within the seed layer. To illustrate, additives included in the ink can include one or more rheology-modifying agents or one or more porosity-modifying agents.

The additives may not provide surface functionalization of the nanoparticles 710 as provided by the ligands 712. The additives may modify the porosity within the final seed layer. The additives are selected to avoid compromising the colloidal stability of the ink 704 and may also be easily removed from a film formed from the ink 704 by moderate heat treatment and/or chemical treatment. Examples of the additives may include polymers that promote uniform self-assembly of nanoparticles in thin films but which can be relatively easily removed through combustion or dissolution. In one or more additional examples, additives can also be introduced into the ink 704 to modify the rheology of the ink 704 in order to improve the coating of the ink 704 on the surface 706 of the current collector layer 708 via one or more solution-phase coating techniques.

The process 700 can also include, at operation 716, performing one or more drying processes to remove at least a portion of the solvent included in the ink 704 and to produce a film 718. The film 718 can include the ligand-functionalized nanoparticles 714.

After the drying process is performed at operation 716, one or more additional thermal treatment processes, one or more chemical treatment processes, or one or more thermal treatment processes and one or more chemical treatment processes can be performed. The one or more thermal treatments can include one or more heat treatments. In one or more additional examples, the one or more thermal treatments can include non-convective thermal treatments. In one or more illustrative examples, the non-convective thermal treatments can include at least one of laser-assisted sintering, microwave-assisted sintering, or optical flash sintering. Critical variables related to the thermal treatment processes and/or the chemical treatment processes can include heat treatment temperature as well as ambient gas composition within a heat treatment chamber.

Additionally, at operation 720, the process 700 can include performing at least one of a first thermal treatment process or a first chemical treatment process with respect to the film 718. In one or more examples, the first thermal treatment process and/or the first chemical treatment process can be performed within a chamber of a system used to produce a nanoparticle seed layer. In one or more examples, a first thermal treatment process can be conducted at a temperature sufficiently high and for a duration to promote necking between nanoparticles, without dramatically reducing overall nanoparticle surface area due to recrystallization. For example, the first thermal treatment process can be performed at temperatures from about 30° C. to 650° C., from 30° C. to 100° C., from 100° C. to 300° C., from 200° C. to 500° C., from 300° C. to 650° C., from 100° C. to 200° C., from 200° C. to 300° C., from 300° C. to 400° C., from 400° C. to 500° C. or from 500° C. to 650° C. The first thermal treatment can also be conducted in an ambient environment that promotes nanoparticle necking without dramatically changing nanoparticle composition. That is, the first thermal treatment process can be conducted in an environment that minimizes oxidation that may take place with respect to the ligand-functionalized nanoparticles 710. In one or more illustrative examples, the first thermal treatment process can be performed in an environment comprised of one or more gases including Nitrogen, Oxygen, Hydrogen, Argon, or one or more combinations thereof. Additionally, the one or more gases can be ionized.

The first chemical treatment process can include exposing the substrate to a bath containing a solution comprising a residual wash solvent and at least one chemical reagent. The bath can be heated to a temperature between 30° C. and 300° C. Additionally, the solution can remove residual organic molecules in the nanostructured seed layer via a dissolution or depolymerization mechanism.

Performing at least one of the first heat treatment process or the first chemical treatment process can produce a modified film 722 that includes a number of intermediate nanoparticle clusters 724. The individual intermediate nanoparticle clusters 724 can include a number of nanoparticles 710 that have been fused together as a result of the first heat treatment process and/or the first chemical treatment process. The individual intermediate nanoparticle clusters 724 can also include a number of ligands 712 coupled to the fused groups of nanoparticles 710. In various examples, at least one of the first heat treatment process or the first chemical treatment process can modify at least one of a shape, volume, or area of the nanoparticles 710 to cause the nanoparticles 710 to become fused to form the intermediate nanoparticle clusters 724.

At operation 726, the process 700 can include performing at least one of a second thermal treatment process or a second chemical treatment process. The second thermal treatment process and/or the second thermal treatment process can produce a seed layer 728. The seed layer 728 can comprise a number of fused nanoparticles 730. Additionally, the seed layer 728 can be electrically conductive, acting as a current collector when disposed on a polymeric substrate.

In various examples, the second heat treatment process and/or the second chemical treatment process can cause the ligands 712 to be removed from the intermediate nanoparticle clusters 724 to produce the fused nanoparticles 730. The seed layer can have a porosity from 1% by volume pores to 99% by volume pores, from 1% by volume pores to 25% by volume pores, from 5% by volume pores to 20% by volume pores, from 10% by volume pores to 30% by volume pores, from 20% by volume pores to 30% by volume pores, from 30% by volume pores to 40% by volume pores, from 40% by volume pores to 50% by volume pores, from 25% by volume pores to 50% by volume pores, from 50% by volume pores to 75% by volume pores, from 50% by volume pores to 60% by volume pores, from 60% by volume pores to 70% by volume pores, from 70% by volume pores to 80% by volume pores, from 80% by volume pores to 90% by volume pores, or from 90% by volume pores to 99% by volume pores.

In one or more examples, at least a portion of the pores of the seed layer 728 can be filled with a solid electrolyte. In various examples, the pores of the seed layer 728 can be filled using liquid-phase infiltration. The solid electrolyte can include a solid polymer electrolyte. In one or more illustrative examples, the solid polymer electrolyte can comprise a polyethylene oxide. In one or more additional illustrative examples, the solid electrolyte can comprise a composite solid electrolyte that includes a polymer and inorganic filler, one or both of which contribute to Li⁺ ion conductivity, such as polyethylene oxide mixed with Li₇La₃Zr₂O₁₂. In one or more illustrative examples, the solid electrolyte can be comprised of a solid inorganic electrolyte. The solid inorganic electrolyte can be comprised of one or more of the following: Li_{w}LaₓM_{y}O₁₂ (where M is Nb, Ta, or Zr), LiₓMP_{y}S_{z} (where M is Ge or Sn), Li_{w}AlₓM_{y}(PO₄)₃ (where M is Ge or Ti), LiₓTi_{y}M_{z}(PO₄)₃ (where M is Cr, Ga, Fe, Sc, In, Lu, Y or La) or NaₓZr₂Si_{y}PO₁₂, where in all cases, x, y and z represent stoichiometric coefficients. In one or more further examples, the electrolyte can be comprised of a solid polymer electrolyte. The solid polymer electrolyte can comprise one or more of the following polymers: polyethylene oxide (PEO), poly vinyl alcohol (PVA), poly methyl methacrylate (PMMA), poly dimethyl siloxane (PDMS), poly(ethylene glycol) dimethacrylate (PEGDMA), poly vinyl pyrollidone (PVP). Such polymers, when combined with lithium salts such as LiClO₄, LiPF₆ or LiNO₃, among others, can yield a solid polymer electrolyte thin film. In one or more illustrative examples, the solid electrolyte can comprise a lithium-containing salt and an organic solvent. The organic solvent can comprise one or more of the following molecules: ethylene carbonate, ethyl methyl carbonate, propylene carbonate, glyme, diglyme, dioxolane, vinylene carbonate, propane sultone, diethyl carbonate, dimethyl carbonate, sulfolane. Additionally, the organic solvent can comprise an ionic liquid such as a salt containing a quaternary phosphorous or nitrogen cation such as 1-ethyl-3-methyl imidazolium or 1-butyl-1-methyl pyrrolidinium. In one or more examples, the lithium-containing salt can comprise one or more of the following molecules: lithium hexafluorophosphate, lithium perchlorate, lithium difluoro(oxalate)borate, lithium trifluoromethanesulfonate, lithium tetrafluoroborate, lithium bis(trifluoromethanesulfonimide), lithium bis(fluorosulfonyl)imide.

In one or more examples, the surface of the seed layer 728 can be further stabilized by the application of a thin-film nanolayer composed of a material that is different from the material of the seed layer 728. Such a material may be described as an “artificial solid-electrolyte interphase (SEI)”. The artificial SEI serves to mitigate the formation of electrochemically-generated SEI during operation of any battery cell that includes seed layer 728. In various examples, the artificial SEI can be applied to the surface of the seed layer 728 via solution-deposition techniques. In one or more illustrative examples, the artificial SEI can be applied to the surface of the seed layer 728 according to one or more implementations described in U.S. patent application Ser. No. 16/244,024, which is incorporated by reference herein in its entirety.

The second thermal treatment process can be distinct from the first thermal treatment process in terms of process conditions such as process environment and process temperature. In one or more additional examples, the second thermal treatment process and the first thermal treatment process can be performed under the same or similar conditions. In one or more examples, the fused nanoparticles 730 can comprise sintered inter-particle connections. In various examples, the fused nanoparticles 730 can be produced using non-convective thermal techniques, such as laser-assisted sintering, optical flash sintering or microwave-assisted sintering. In various examples, the second chemical treatment process can be distinct from the second chemical treatment process. Further, the second chemical treatment process and the first chemical treatment process can be performed under the same or similar conditions. In various examples, the at least one of the second thermal treatment process or the second chemical treatment process can be optional.

In one or more further examples, to help reduce oxidation of metallic nanoparticles, nanoparticles can be applied to a current collector that are free of ligands. In these scenarios, metal-organic decomposition inks can be applied to a current collector. The inks can include a solvent. In one or more illustrative examples, an ink applied to the current collector can include an organo-metallic ink. The ink can include at least one of a solvent or a porogen. In various examples, the inks can include one or more additives to stabilize the inks. The ink can include metal-organic nanoparticles that are precursors used to form the nanostructured seed layer. In at least some examples, at least one of one or more heat treatments or one or more chemical treatments can be applied to cause the organometallic precursors included in the ink to become fused to an underlying current collector and to themselves to form the nanostructured seed layer. In various examples, the one or more heat treatments can include non-convective thermal techniques, such as laser-assisted sintering, optical flash sintering or microwave-assisted sintering. The one or more heat treatments can be performed at temperatures from about 50° C. to about 500° C. for a duration from about 1 minute to about 6 hours. The one or more heat treatments and/or one or more chemical treatments can be performed in an inert atmosphere. The inert atmosphere can be performed in a reducing environment that includes an inert gas, such as argon and/or nitrogen. The final product can include a metallic nanoparticle film that serves as a seed layer for the deposition of a metal layer on the current collector substrate having the nanostructured seed layer. In this way, the fused nanoparticles 730 can be produced using a process that is different from the process that utilizes ligand-functionalized nanoparticles.

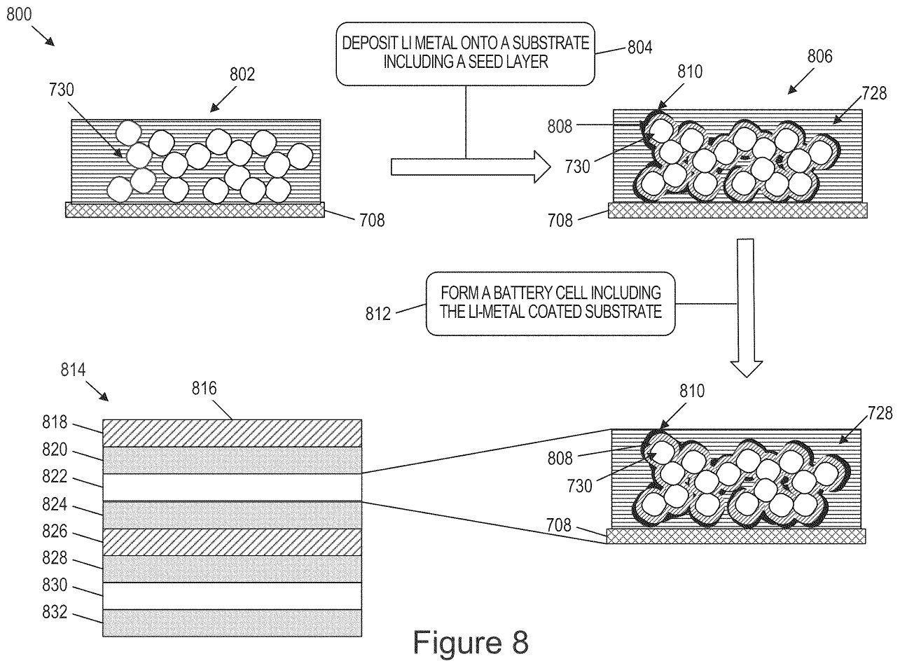

FIG. 8 illustrates an example process 800 to produce a lithium metal coated substrate. The process 800 can include providing a substrate 802 that includes the current collector layer 708 and the seed layer 728 that comprises the fused nanoparticles 730. At 804, the process 800 can include depositing lithium (Li) metal onto the substrate 802. Depositing the Li metal onto the substrate 802 can produce a lithium metal-coated substrate 806. The lithium metal-coated substrate 806 can comprise the fused nanoparticles 730 with a Li metal layer 808 disposed on the fused nanoparticles 730. Depositing the Li metal onto the substrate 802 can be performed using an electrodeposition process. The electrodeposition process can take place in an electrodeposition bath. The electrodeposition bath can comprise an electrolyte, a lithium-containing salt, and a counter electrode. The electrolyte can comprise a lithium-containing salt and an organic solvent. The counter electrode can comprise Lithium metal.

The organic solvent can comprise one or more of the following molecules: ethylene carbonate, ethyl methyl carbonate, propylene carbonate, glyme, diglyme, dioxolane, vinylene carbonate, propane sultone, diethyl carbonate, dimethyl carbonate, sulfolane. Additionally, the organic solvent can comprise an ionic liquid such as a salt containing a quaternary phosphorous or nitrogen cation such as 1-ethyl-3-methyl imidazolium or 1-butyl-1-methyl pyrrolidinium. In one or more examples, the lithium-containing salt can comprise one or more of the following molecules: lithium hexafluorophosphate, lithium perchlorate, lithium difluoro(oxalate)borate, lithium trifluoromethanesulfonate, lithium tetrafluoroborate, lithium bis(trifluoromethanesulfonimide), lithium bis(fluorosulfonyl)imide.

In one or more examples, the Li metal layer 808 can be an initial, pre-deposition layer. In various examples, the Li metal can be electrodeposited onto the substrate 802 within a bath containing Li metal or other suitable counter electrode and Li salts. The bath can also include one or more electrolytes, such as ionic liquids. In one or more illustrative examples, solid-electrolyte-interphase (SEI)8710 can be formed on the Li metal layer 708. The advantages of performing the pre-deposition process can include:
a. introducing a quantity of Li metal onto the substrate 802 prior to forming a battery cell, can provide a “reservoir” of excess Li to compensate for Li consumed to form the SEI 810 (or due to other parasitic losses) during battery operation
b. pre-generating an SEI 810 on top of the pre-deposited Li metal layer 808, can eliminate some quantity of the formation of SEI 810 during battery operation.
   In one or more implementations, the pre-deposition process performed at operation 804 can be conducted using roll-to-roll electrodeposition bath equipment.

The process 800 can also include, at operation 812, forming a battery cell 814 that includes the lithium metal-coated substrate 806. In one or more examples, the lithium metal-coated substrate 806 can comprise an electrode of the battery cell 814. In one or more illustrative examples, the lithium metal-coated substrate 806 can comprise an anode of the battery cell 814. The battery cell 814 can be one of a plurality of battery cells included in a battery. The average thickness of the lithium metal layer 808 when the battery is in a fully charged state ranges from 1 Angstrom to 10000 nm. In various examples, the average thickness of the lithium metal layer 808 in can increase when the battery is charged with respect to the initial thickness of the lithium metal layer 808 of the lithium metal-coated substrate 806.

The battery can be a power supply used in a number of implementations. For example, the battery can be a power source for a consumer electronics device, such as a smart phone, a laptop computing device, a wearable computing device, a tablet computing device, a portable gaming device, and/or a desktop computer device. Additionally, the battery can be a power source for an electric vehicle. In one or more further examples, the battery can be a power source for other vehicles, such as aircraft and unmanned aerial vehicles. The battery can also provide energy storage as part of an electricity grid that provides power to buildings, municipalities, and the like.

The battery cell 814 can include a housing 816. The housing 816 can be comprised of one or more metallic materials. The housing 816 can also be comprised of one or more polymeric materials. A number of layers can be disposed within the housing 816. For example, one or more separator layers can be disposed within the housing 816. In addition, one or more electrolyte layers can be disposed within the housing 816. Further, a number of electrode layers can be disposed within the housing 816. For example, a number of anode layers and a number of cathode layers can be disposed within the housing 816.

In one or more illustrative examples, a first separator layer 818 can be disposed within the housing 816. Additionally, a first electrolyte layer 820 can be disposed within the housing 816. Further, a first electrode layer 822 can be disposed within the housing 816. In the illustrative example of FIG. 8, the lithium metal-coated substrate 806 can comprise the first electrode layer 822. A second electrolyte layer 824 can be disposed in the housing 816 in addition to a second separator layer 826. In various examples, the housing 816 can include a third electrolyte layer 828 and a second electrode layer 830. In one or more examples, the housing 816 can also include a fourth electrolyte layer 832. In one or more instances, the first electrode layer 822 can correspond to an anode layer and the second electrode layer 830 can correspond to a cathode layer. In one or more additional instances, the first electrode layer 822 can correspond to a cathode layer and the second electrode layer 830 can correspond to an anode layer. In scenarios where the first electrode layer 822 comprises an anode layer, the second electrode layer 830 can include a cathode layer that is comprised of LiNiₓMn_{y}Co_{z}O₂, LiNiₓCo_{y}Al_{z}O₂, LiMnₓNi_{y}O_{z}, LiMnO₂, LiFePO₄, LiMnPO₄, LiNiPO₄, LiCoPO₄, LiV₂O₅, sulfur or LiCoO₂ where x, y and z are stoichiometric coefficients.

Although the illustrative example of FIG. 8 shows an arrangement of layers of the battery cell 814, in additional implementations, a different number and a different arrangement of layers can be disposed in the housing 816 of the battery cell 814. Further, additional layers not shown in the illustrative example of FIG. 8 can also be disposed in the housing 816.

A numbered non-limiting list of aspects of the present subject matter is presented below.

Aspect 1. A device comprising: a battery electrode including: a substrate having one or more polymeric materials; and a layer disposed on the substrate, the layer including one or more conductive materials, having a thickness no greater than 12 micrometers, and having a measure of porosity of at least 5% by volume.

Aspect 2. The device of aspect 1, wherein the one or more conductive materials include at least one of copper, aluminum, titanium, nickel, or stainless steel.

Aspect 3. The device of aspect 1 or 2, wherein the one or more polymeric materials have a glass transition temperature no greater than 250° C.

Aspect 4. The device of any one of aspects 1-3, wherein the one or more polymeric materials include at least one of a polyethylene, a polyethylene glycol, a polypropylene, a polyimide, a polyether ether ketone, a polyester, polyethylene terephthalate, a polyamide, a polyvinylchloride, a polyacrylate, or a polyethylene naphthalate.

Aspect 5. The device of any one of aspects 1-4, wherein the one or more conductive materials are formed as a number of particles having a spherical morphology.

Aspect 6. The device of any one of aspects 1-5, wherein the one or more conductive materials are formed as a number of particles having a nanowire morphology.

Aspect 7. The device of any one of aspects 1-6, wherein the layer includes one or more electrode active materials.

Aspect 8. The device of aspect 7, wherein the one or more electrode active materials correspond to an anode and comprise at least one of graphite, Si, Sn, Ge, Al, P, Zn, Ga, As, Cd, In, Sb, Pb, Bi, SiO, SnO₂, Si, Sn, lithium metal, LiNiₓMn_{y}Co_{z}O₂, LiNiₓCo_{y}Al₂O₂, LiMnₓNi_{y}O_{z}, LiMnO₂, LiFePO₄, LiMnPO₄, LiNiPO₄, LiCoPO₄, LiV₂O₅, sulfur, or LiCoO₂ where x, y and z are stoichiometric coefficients.

Aspect 9. The device of aspect 7, wherein the layer includes one or more binding materials to cause the one or more electrode active materials to bind with the one or more conductive materials.

Aspect 10. The device of aspect 9, wherein the one or more binding materials include at least one of a polyvinylidene fluoride, a polyamide imide, a polyethylene oxide, a polyimide, a poly (acrylic acid), a poly (methyl methacrylate), a polyvinyl alcohol, or a polypropylene carbonate.

Aspect 11. The device of aspect 9 or 10, wherein the layer includes one or more conductive additives comprising at least one of carbon black particles, carbon nanotubes, or graphite particles.

Aspect 12. The device of any one of aspects 1-6, wherein the layer is a current collector layer and the battery electrode includes an active material layer comprising one or more electrode active materials.

Aspect 13. The device of aspect 12, wherein the one or more electrode active materials correspond to an anode and comprise at least one of graphite, Si, Sn, Ge, Al, P, Zn, Ga, As, Cd, In, Sb, Pb, Bi, SiO, SnO₂, Si, Sn, lithium metal, LiNiₓMn_{y}Co_{z}O₂, LiNiₓCo_{y}Al_{z}O₂, LiMnₓNi_{y}O_{z}, LiMnO₂, LiFePO₄, LiMnPO₄, LiNiPO₄, LiCoPO₄, LiV₂O₅, sulfur, or LiCoO₂ where x, y and z are stoichiometric coefficients.

Aspect 14. The device of aspect 12, wherein the active material layer includes one or more binding materials to cause the one or more electrode active materials to bind with the one or more conductive materials.

Aspect 15. The device of aspect 14, wherein the one or more binding materials include at least one of a polyvinylidene fluoride, a polyamide imide, a polyethylene oxide, a polyimide, a poly (acrylic acid), a poly (methyl methacrylate), a polyvinyl alcohol, or a polypropylene carbonate.

Aspect 16. The device of aspect 14 or 15, wherein the active material layer includes one or more conductive additives comprising at least one of carbon black particles, carbon nanotubes, or graphite particles.

Aspect 17. The device of any one of aspects 1-16, wherein the substrate is formed into a first sheet and the layer disposed on the substrate is formed into a second sheet disposed on the first sheet.

Aspect 18. The device of any one of aspects 1-17, wherein the battery electrode is included in a lithium-ion battery.

Aspect 19. The device of any one of aspects 1-18, wherein the layer includes pores having diameters no greater than 10 nanometers.

Aspect 20. The device of any one of aspects 1-19, wherein the substrate has a porosity of at least 5% by volume.

Aspect 21. The device of any one of aspects 1-20, wherein an encapsulating thin layer is formed on the one or more conductive materials.

Aspect 22. The device of any one of aspects 1-21, wherein the layer includes one or more fire retardant additives comprised of at least one of ammonium polyphosphate, ammonium sulfate, sodium borate, melamine, or pentaerythritol.

Aspect 23. The device of any one of aspects 1-22, wherein the layer includes one or more first thermal management additives comprised of at least one of a polyethylene, a polypropylene, a polystyrene, a polyethylene terephthalate, a polytetrafluoroethylene, a polycarbonate, or a polyvinyl chloride.

Aspect 24. The device of any one of aspects 1-23, wherein the layer includes one or more second thermal management additives comprised of at least one of an ethylene-vinyl acetate, a polyvinyl alcohol, a polycaprolactone, silicone, a polyurethane, or naphthalene.

Aspect 25. A method comprising: providing a substrate for a battery electrode, the substrate including one or more polymeric materials; and forming a layer on the substrate, wherein the layer includes one or more conductive materials, having a thickness no greater than 12 micrometers, and has a measure of porosity of at least 5% by volume.

Aspect 26. The method of aspect 25, wherein forming the layer on the substrate includes depositing an ink on the substrate.

Aspect 27. The method of aspect 26, comprising: applying one or more thermal treatments to the ink after the ink is deposited on the substrate, wherein the one or more thermal treatments are performed at temperatures no greater than about 250° C.

Aspect 28. The method of aspect 27, wherein the one or more thermal treatments are performed in an environment including one or more gases that include at least one of nitrogen, oxygen, hydrogen, or argon.

Aspect 29. The method of aspect 28, wherein the one or more gases are ionized.

Aspect 30. The method of any one of aspects 25-29, comprising: performing a solution-phase coating process to form the layer on the substrate.

Aspect 31. The method of aspect 30, wherein the solution-phase coating process includes at least one of a slot-die process, a spray process, an aerosol process, a bath process, a gravure coating process, a comma coating process, or a dip coating process.

Aspect 32. The method of any one of aspects 26-31, wherein the ink includes first particles comprised of the one or more conductive materials and one or more solvents.

Aspect 33. The method of aspect 32, wherein the one or more solvents include one or more organic solvents.

Aspect 34. The method of aspect 32 or 33, wherein the one or more solvents include at least one of isopropyl alcohol, ethanol, methanol, tert-butanol, 1-butanol, 2-Amino-2-methyl-1-propanol, amino-2-propanol, 2-methoxyethanol, ethylene glycol, dipropylene glycol monomethyl ether, diethylene glycol methyl ether, benzyl alcohol, pyridine, tetrahydrofuran (THF), hexane, toluene, or water.

Aspect 35. The method of any one of aspects 32-34, wherein the ink includes second particles comprising one or more electrode active materials.

Aspect 36. The method of aspect 35, wherein the one or more electrode active materials correspond to an anode and comprise at least one of graphite, Si, Sn, Ge, Al, P, Zn, Ga, As, Cd, In, Sb, Pb, Bi, SiO, SnO₂, Si, Sn, lithium metal, LiNiₓMn_{y}Co_{z}O₂, LiNiₓCo_{y}Al_{z}O₂, LiMnₓNi_{y}O_{z}, LiMnO₂, LiFePO₄, LiMnPO₄, LiNiPO₄, LiCoPO₄, LiV₂O₅, sulfur, or LiCoO₂ where x, y and z are stoichiometric coefficients.

Aspect 37. The method of aspects 35 or 36, wherein the ink includes one or more binding materials to cause the one or more electrode active materials to bind with the one or more conductive materials.

Aspect 38. The method of aspect 37, wherein one or more binding materials include at least one of a polyvinylidene fluoride, a polyamide imide, a polyethylene oxide, a polyimide, a poly (acrylic acid), a poly (methyl methacrylate), a polyvinyl alcohol, or a polypropylene carbonate.

Aspect 39. The method of any one of aspects 36-38, wherein the ink includes one or more conductive additives comprising at least one of carbon black particles, carbon nanotubes, or graphite particles.

Aspect 40. The method of any one of aspects 35-39, wherein the ink includes one or more fire retardant additives comprised of at least one of ammonium polyphosphate, ammonium sulfate, sodium borate, melamine, or pentaerythritol.

Aspect 41. The method of any one of aspects 35-40, wherein the layer includes one or more first thermal management additives comprised of at least one of a polyethylene, a polypropylene, a polystyrene, a polyethylene terephthalate, a polytetrafluoroethylene, a polycarbonate, or a polyvinyl chloride.

Aspect 42. The method of any one of aspects 35-41, wherein the layer includes one or more second thermal management additives comprised of at least one of an ethylene-vinyl acetate, a polyvinyl alcohol, a polycaprolactone, silicone, a polyurethane, or naphthalene.

Aspect 43. The method of any one of aspects 26-34, wherein the layer is a current collector layer, and the method comprises: forming an active material layer on the current collector layer, the active material layer comprising an active material of the battery electrode.

Aspect 44. The method of aspect 43, wherein forming the active material layer on the current collector layer includes depositing an additional ink on the current collector layer.

Aspect 45. The method of aspect 44, comprising: applying one or more additional thermal treatments to the additional ink after the additional ink is deposited on the current collector layer, wherein the one or more additional thermal treatments are performed at temperatures no greater than about 250° C.

Aspect 46. The method of aspect 45, wherein the one or more additional thermal treatments are performed in an environment including one or more gases that include at least one of nitrogen, oxygen, hydrogen, ozone, or argon.

Aspect 47. The method of aspect 46, wherein the one or more gases are ionized.

Aspect 48. The method of any one of aspects 43-47, comprising: performing an additional solution-phase coating process to form the active material layer on the current collector layer.

Aspect 49. The method of aspect 48, wherein the additional solution-phase coating process includes at least one of a slot-die process, a spray process, an aerosol process, a bath process, a gravure coating process, a comma coating process, or a dip coating process.

Aspect 50. The method of any one of aspects 25-49, comprising performing one or more pretreatment processes with respect to the substrate prior to forming the layer on the substrate, the one or more pretreatment processes including at least one of ultraviolet-ozone, corona discharge, atmospheric plasma, or applying one or more chemical solutions to the substrate.

Aspect 51. The method of any one of aspects 25-50, comprising performing one or more thermal treatments with respect to at least one of the one or more conductive materials or one or more conductive material-active electrode material complexes disposed on the substrate, the one or more thermal treatments including at least one of optical flash sintering, spark plasma sintering, ultrasonic sintering, or microwave sintering.

Aspect 52. A formulation comprising: one or more solvents; first particles comprised of one or more conductive materials; and second particles comprised of one or more electrode active materials.

Aspect 53. The formulation of aspect 52, wherein the one or more conductive materials include at least one of copper, aluminum, titanium, nickel, or stainless steel.

Aspect 54. The formulation of aspect 52 or 53, wherein the one or more solvents include at least one of isopropyl alcohol, ethanol, methanol, tert-butanol, 1-butanol, 2-Amino-2-methyl-1-propanol, amino-2-propanol, 2-methoxyethanol, ethylene glycol, dipropylene glycol monomethyl ether, diethylene glycol methyl ether, benzyl alcohol, pyridine, tetrahydrofuran (THF), hexane, toluene, or water.

Aspect 55. The formulation of any one of aspects 52-54, wherein the one or more electrode active materials correspond to an anode and comprise at least one of graphite, Si, Sn, Ge, Al, P, Zn, Ga, As, Cd, In, Sb, Pb, Bi, SiO, SnO₂, Si, Sn, lithium metal, LiNiₓMn_{y}Co_{z}O₂, LiNiₓCo_{y}Al_{z}O₂, LiMnₓNi_{y}O_{z}, LiMnO₂, LiFePO₄, LiMnPO₄, LiNiPO₄, LiCoPO₄, LiV₂O₅, sulfur, or LiCoO₂where x, y and z are stoichiometric coefficients.

Aspect 56. The formulation of any one of aspects 52-55, including third particles comprising one or more binding materials to cause the one or more electrode active materials to bind with the one or more conductive materials.

Aspect 57. The formulation of aspect 56, wherein one or more binding materials include at least one of a polyvinylidene fluoride, a polyamide imide, a polyethylene oxide, a polyimide, a poly (acrylic acid), a poly (methyl methacrylate), a polyvinyl alcohol, or a polypropylene carbonate.

Aspect 58. The formulation of any one of aspects 52-57, including fourth particles comprising one or more conductive additives comprising at least one of carbon black particles, carbon nanotubes, or graphite particles.

Aspect 59. The formulation of any one of aspects 52-58, comprising an ink having the first particles and the second particles.

Aspect 60. The formulation of any one of aspects 52-59, comprising one or more fire retardant additives comprised of at least one of ammonium polyphosphate, ammonium sulfate, sodium borate, melamine, or pentaerythritol.

Aspect 61. The formulation of any one of aspects 52-60, comprising one or more first thermal management additives comprised of at least one of a polyethylene, a polypropylene, a polystyrene, a polyethylene terephthalate, a polytetrafluoroethylene, a polycarbonate, or a polyvinyl chloride.

Aspect 62. The formulation of any one of aspects 52-61, comprising one or more second thermal management additives comprised of at least one of an ethylene-vinyl acetate, a polyvinyl alcohol, a polycaprolactone, silicone, a polyurethane, or naphthalene.

Aspect 63. A method for producing a substrate comprising a nanostructured seed layer on one or more surfaces of a current collector, the method comprising: providing an ink comprising a solution comprising at least ligand-functionalized nanoparticles and a solvent; applying a thin wet film of the ink to the current collector using a solution-phase thin-film coating process, wherein the current collector comprises one or more polymeric materials; drying the thin wet film to produce a thin dry film of ligand-functionalized nanoparticles; and performing one or more thermal treatments and/or chemical treatments to the thin dry film, thereby producing a substrate comprising a free-standing, porous nanostructured seed layer on one or more surfaces of a current collector.

Aspect 64. The method of aspect 63, wherein the nanoparticle is composed of a metal.

Aspect 65. The method of aspect 64, wherein the metal possesses a bulk resistivity of 1×10⁻¹² Ohm-cm to 1 Ohm-cm.

Aspect 66. The method of any one of aspects 63-65, wherein the nanoparticle is composed of a semiconductor.

Aspect 67. The method of aspect 66, wherein the semiconductor possesses a bulk resistivity of 1 Ohm-cm to 1000 Ohm-cm.

Aspect 68. The method of any one of aspects 63-67, wherein the nanoparticle is composed of an insulator.

Aspect 69. The method of aspect 68, wherein the insulator possesses a bulk resistivity of 1000 Ohm-cm to 1×10¹³ Ohm-cm.

Aspect 70. The method of any one of aspects 63-69, wherein the nanoparticle possesses a spherical geometry.

Aspect 71. The method of any one of aspects 63-70, wherein the nanoparticle possesses a multi-faceted polyhedral geometry.

Aspect 72. The method of aspect 71, wherein the nanoparticle possesses a diameter between 1 Angstrom and 100 nm.

Aspect 73. The method of aspect 72, wherein any dimension of the nanoparticle polyhedral geometry possesses a length between 1 Angstrom and 100 nm.

Aspect 74. The method of any one of aspects 63-73, wherein the ligand is a molecule comprising a chelating group that coordinates with nanoparticle surfaces and a solubilizing group that renders the nanoparticle dispersible in a solvent.

Aspect 75. The method of any one of aspects 63-74, comprising adding organic molecules to the ink in step (a).

Aspect 76. The method of any one of aspects 63-75, wherein the dry film in step (c) is subjected to one or more heat treatments ranging in temperature from 30 to 650° C.

Aspect 77. The method of aspect 76, wherein the one or more thermal treatments is performed in an ambient atmosphere containing gases composed of Nitrogen, Oxygen, Hydrogen, Argon, or some combination thereof.

Aspect 78. The method of aspect 77, wherein one or more of the gases are ionized.

Aspect 79. The method of any one of aspects 63-78, wherein the solution-phase coating process is a slot-die, spray, aerosol, bath, gravure, comma or dip coating process.

Aspect 80. The method of any one of aspects 63-79, wherein the ink further comprises a rheology-modifying agent or a porosity-modifying agent.

Aspect 81. The method of any one of aspects 63-80, wherein the porosity of the nanostructured seed layer ranges from 1%-99%.

Aspect 82. The method of any one of aspects 63-81, wherein the one or more chemical treatments comprises exposing the substrate to a bath containing a solution comprising a residual wash solvent and at least one chemical reagent.

Aspect 83. The method of aspect 82, wherein the bath is heated to a temperature between 30° C. and 300° C.

Aspect 84. The method of aspect 82, wherein the solution removes residual organic molecules in the nanostructured seed layer via a dissolution or depolymerization mechanism.

Aspect 85. The method of any one of aspects 63-84, wherein at least a portion of pores in the nanostructured seed layer are backfilled with a solid electrolyte.

Aspect 86. The method of aspect 85, wherein the solid electrolyte comprises a solid polymer electrolyte.

Aspect 87. The method of aspect 86, wherein the solid polymer electrolyte comprises polyethylene oxide.

Aspect 88. The method of aspect 86, wherein the solid polymer electrolyte comprises one or more of the following polymers: polyethylene oxide (PEO), poly vinyl alcohol (PVA), poly methyl methacrylate (PMMA), poly dimethyl siloxane (PDMS), poly(ethylene glycol) dimethacrylate (PEGDMA), or poly vinyl pyrollidone (PVP).

Aspect 89. The method of aspect 85, wherein the solid electrolyte comprises a composite solid electrolyte comprising a polymer and inorganic filler.

Aspect 90. The method of aspect 89, wherein at least one of the polymer or the inorganic filler contribute to Li⁺ ion conductivity.

Aspect 91. The method of aspect 85, wherein the solid electrolyte comprises polyethylene oxide mixed with Li₇La₃Zr₂O₁₂.

Aspect 92. The method of aspect 85, wherein the solid electrolyte comprises a solid inorganic electrolyte.

Aspect 93. The method of aspect 92, wherein the solid inorganic electrolyte comprises one or more of Li_{w}LaₓM_{y}O₁₂ (where M is Nb, Ta, or Zr), LiₓMP_{y}S_{z} (where M is Ge or Sn), Li_{w}AlₓM_{y}(PO₄)₃ (where M is Ge or Ti), LiₓTi_{y}M_{z}(PO₄)₃ (where M is Cr, Ga, Fe, Sc, In, Lu, Y or La) or NaₓZr₂Si_{y}PO₁₂, x, y and z represent stoichiometric coefficients.

Aspect 94. The method of aspect 85, wherein the solid electrolyte comprises a lithium-containing salt and an organic solvent.

Aspect 95. The method of aspect 94, wherein organic solvent comprises at least one of ethylene carbonate, ethyl methyl carbonate, propylene carbonate, glyme, diglyme, dioxolane, vinylene carbonate, propane sultone, diethyl carbonate, dimethyl carbonate, or sulfolane.

Aspect 96. The method of aspect 94, wherein the organic solvent includes an ionic liquid.

Aspect 97. The method of aspect 96, wherein the ionic liquid comprises a quaternary phosphorous or a nitrogen cation.

Aspect 98. The method of aspect 97, wherein the ionic liquid comprises 1-ethyl-3-methyl imidazolium or 1-butyl-1-methyl pyrrolidinium.

Aspect 99. The method of aspect 94, wherein the lithium-containing salt includes at least one of lithium hexafluorophosphate, lithium perchlorate, lithium difluoro(oxalate)borate, lithium trifluoromethanesulfonate, lithium tetrafluoroborate, lithium bis(trifluoromethanesulfonimide), or lithium bis(fluorosulfonyl)imide.

Aspect 100. The method of any one of aspects 63-99, wherein the current collector comprises a foil.

Aspect 101. The method of any one of aspects 63-100, where the nanostructured seed layer is rendered electrically conductive by electroless plating with one or more metals.

Aspect 102. The method of any one of aspects 63-101, wherein a non-convective thermal treatment is performed in addition to or in lieu of a heat treatment or chemical treatment.

Aspect 103. The method of aspect 102, wherein the non-convective thermal treatment comprises laser-assisted sintering, microwave-assisted sintering, or optical flash sintering.

Aspect 104. The method of any one of aspects 63-103, where the seed layer is composed of at least two different types of nanoparticles wherein the at least two different nanoparticles are composed of different materials.

Aspect 105. The method of any one of aspects 63-104, wherein the seed layer is composed of core-shell nanoparticles, wherein the core is composed of one material and the shell is composed of a different material.

Aspect 106. The method of any one of aspect 63-105, comprising: forming an artificial solid-electrolyte interphase layer on at least a portion of the seed layer.

Aspect 107. The method of aspect 106, wherein the artificial solid-electrolyte interphase layer includes one or more monolayers.

Aspect 108. The method of aspect 106 or 107, wherein the artificial solid-electrolyte interphase layer includes a metallic material.

Aspect 109. The method of any one of aspects 106-108, wherein the artificial solid-electrolyte interphase layer includes a polymeric material.

Aspect 110. The method of any one of aspects 63-109, wherein the one or more polymeric materials comprise at least one of polyethylene, polypropylene, polyimide, polyether ether ketone, polyester, polyamide, or polyethylene napthalate.

Aspect 111. The method of any one of aspects 63-110, wherein the one or more polymeric materials comprise one or more metals.

Aspect 112. The method of aspect 111, wherein the one or more metals comprise at least one of copper, titanium, nickel, or stainless steel.

Aspect 113. The method of any one of aspects 63-110, wherein the current collector is entirely composed of the one or more polymeric materials.

Aspect 114. The method of any one of aspects 63-113, wherein the nanostructured seed layer deposited on the current collector is electrically conductive.

Aspect 115. A method for producing a lithium-metal coated substrate, the method comprising: providing a substrate comprising a nanoparticle seed layer on one or more surfaces of a current collector; and electrodepositing lithium onto the nanoparticle seed layer of the substrate to form a lithium metal-coated substrate.

Aspect 116. The method of aspect 115, wherein the substrate comprising the nanoparticle seed layer on one or more surfaces of a current collector is produced by any one of the methods of aspects 63 to 114.

Aspect 117. The method of aspect 115, wherein the electrodepositing occurs in an electrodeposition bath comprising an electrolyte, a lithium-containing salt, and a counter electrode.

Aspect 118. The method of aspect 117, wherein the electrolyte is composed of a lithium-containing salt and an organic solvent.

Aspect 119. The method of aspect 118, wherein the organic solvent comprises one or more of the following molecules: ethylene carbonate, ethyl methyl carbonate, propylene carbonate, glyme, diglyme, dioxolane, vinylene carbonate, propane sultone, diethyl carbonate, dimethyl carbonate, sulfolane.

Aspect 120. The method of aspect 118 or 119, wherein the lithium-containing salt comprises one or more of the following molecules: lithium hexafluorophosphate, lithium perchlorate, lithium difluoro(oxalate)borate, lithium trifluoromethanesulfonate, lithium tetrafluoroborate, lithium bis(trifluoromethanesulfonimide), lithium bis(fluorosulfonyl)imide.

Aspect 121. The method of aspect 118, wherein the organic solvent comprises an ionic liquid such as a salt containing a quaternary phosphorous or nitrogen cation such as 1-ethyl-3-methyl imidazolium or 1-butyl-1-methyl pyrrolidinium.

Aspect 122. The method of aspect 115, wherein the method occurs prior to assembly of the lithium-metal coated substrate with a cathode, an electrolyte, a separator, and a housing to form a battery.

Aspect 123. The method of aspect 122, wherein the average lithium metal thickness on the nanostructured seed layer when the battery is in a fully charged state ranges from 1 Angstrom to 1000 nm.

Aspect 124. The method of aspect 122, wherein the cathode is composed of LiNiₓMn_{y}Co_{z}O₂, LiNiₓCo_{y}Al_{z}O₂, LiMnₓNi_{y}O_{z}, LiMnO₂, LiFePO₄, LiMnPO₄, LiNiPO₄, LiCoPO₄, LiV₂O₅, sulfur or LiCoO₂ where x, y and z are stoichiometric coefficients.

Aspect 125. The method of any one of aspects 115-124, wherein the nanoparticle seed layer is produced according to the method of any one of aspects 63-114.

Aspect 126. A battery comprising a lithium-metal coated substrate produced by any one of the methods of aspects 63 to 114.

Aspect 127. The battery of aspect 126, wherein the average lithium metal thickness on the nanostructured seed layer when the battery is in a fully charged state ranges from 1 Angstrom to 1000 nm.

Aspect 128.The battery of aspect 126, further comprising a cathode, wherein the cathode is composed of LiNiₓMn_{y}Co_{z}O₂, LiNiₓCo_{y}Al_{z}O₂, LiMnₓNi_{y}O_{z}, LiMnO₂, LiFePO₄, LiMnPO₄, LiNiPO₄, LiCoPO₄, LiV₂O₅, sulfur or LiCoO₂ where x, y and z are stoichiometric coefficients.

Aspect 129. A substrate comprising a nanostructured seed layer on one or more surfaces of a current collector.

Aspect 130. The substrate of aspect 129, wherein the substrate is produced by a method of any one of aspects 63-114.

Aspect 131. A battery comprising: a housing; one or more battery cells disposed within the housing, an individual battery cell of the one or more battery cells comprising: an electrode layer including (i) a seed layer comprised of a number of fused nanoparticles and (ii) a lithium metal layer disposed on the number of fused nanoparticles; one or more separator layers; and one or more electrolyte layers comprising an electrolyte.

Aspect 132. The battery of aspect 131, wherein the seed layer includes a number of pores, and at least a portion of the number of pores are filled with an additional electrolyte.

Aspect 133. The battery of aspect 132, wherein the additional electrolyte is composed of a lithium-containing salt and an organic solvent.

Aspect 134. The battery of aspect 132, wherein the organic solvent comprises one or more of the following molecules: ethylene carbonate, ethyl methyl carbonate, propylene carbonate, glyme, diglyme, dioxolane, vinylene carbonate, propane sultone, diethyl carbonate, dimethyl carbonate, sulfolane

Aspect 135. The battery of aspect 132, wherein the lithium-containing salt comprises one or more of the following molecules: lithium hexafluorophosphate, lithium perchlorate, lithium difluoro(oxalate)borate, lithium trifluoromethanesulfonate, lithium tetrafluoroborate, lithium bis(trifluoromethanesulfonimide), lithium bis(fluorosulfonyl)imide.

Aspect 136. The battery of aspect 132, wherein the organic solvent includes an ionic liquid.

Aspect 137. The battery of aspect 136, wherein the ionic liquid comprises a quaternary phosphorous or a nitrogen cation.

Aspect 138. The battery of aspect 137, wherein the ionic liquid comprises 1-ethyl-3-methyl imidazolium or 1-butyl-1-methyl pyrrolidinium.

Aspect 139. The battery of aspect 132, wherein the additional electrolyte is composed of a solid inorganic electrolyte comprising one or more of the following: Li_{w}LaₓM_{y}O₁₂ (where M is Nb, Ta, or Zr), Liₓ¬MP_{y}S_{z} (where M is Ge or Sn), Li_{w}AlₓM¬_{y}(PO₄)₃ (where M is Ge or Ti), LiₓTi_{y}M_{z}(PO₄)₃ (where M is Cr, Ga, Fe, Sc, In, Lu, Y or La) or NaₓZr₂Si_{y}PO₁₂, where in all cases, x, y and z represent stoichiometric coefficients.

Aspect 140. The battery of aspect 132, wherein the additional electrolyte is composed of a solid polymer electrolyte comprising one or more of the following polymers: polyethylene oxide (PEO), poly vinyl alcohol (PVA), poly methyl methacrylate (PMMA), poly dimethyl siloxane (PDMS), poly(ethylene glycol) dimethacrylate (PEGDMA), poly vinyl pyrollidone (PVP). Such polymers, when combined with lithium salts such as LiClO₄, LiPF₆ or LiNO₃, among others, can yield a solid polymer electrolyte thin film.

Aspect 141. The battery of aspect 132, wherein the additional electrolyte comprises a composite solid electrolyte comprising a polymer and inorganic filler.

Aspect 142. The battery of aspect 141, wherein at least one of the polymer or the inorganic filler contribute to Li⁺ ion conductivity.

Aspect 143. The battery of aspect 133, wherein the additional electrolyte comprises polyethylene oxide mixed with Li₇La₃Zr₂O₁₂.

Aspect 144. A formulation comprising: a solvent; a plurality of nanoparticles disposed within the solvent, the plurality of nanoparticles having one or more dimensions from about 0.5 nanometers to about 500 nm; one or more ligands coupled to individual nanoparticles of the plurality of nanoparticles, the one or more ligands having a molecular weight from 20 daltons (Da) to 10 kDa.

Aspect 145. The formulation of aspect 144, wherein the one or more ligands functionalize surfaces of at least a portion of the plurality of nanoparticles.

Aspect 146. The formulation of aspect 144 or 145, wherein the one or more ligands include an ion conductive material.

Aspect 147. The formulation of any one of aspects 144-146, wherein the one or more ligands include a molecule having a chelating group.

Aspect 148. The formulation of any one of aspects 144-147, wherein at least a portion of the plurality of nanoparticles are comprised of one or more metallic materials.

Aspect 149. The formulation of any one of aspects 144-148, wherein at least a portion of the plurality of nanoparticles are comprised of one or more semiconducting materials.

Aspect 150. The formulation of any one of aspects 144-147, wherein at least a portion of the plurality of nanoparticles are comprised of one or more insulating materials.

Aspect 151. The formulation of any one of aspects 144-150, wherein the plurality of nanoparticles avoid introducing an excessive direct current resistance during operation of a battery comprising the plurality of nanoparticles.

Aspect 152. The formulation of any one of aspects 144-151, wherein the plurality of nanoparticles comprise a first group of nanoparticles having a first composition and a second plurality of nanoparticles having a second composition.

Aspect 153. The formulation of aspect 152, wherein at least a portion of the plurality of nanoparticles have a core-shell shape with an inner core comprised of one or more first materials and an outer shell disposed around the inner core comprised of one or more second materials.

Aspect 154. The formulation of any one of aspects 144-153, comprising one or more additives.

Aspect 155. The formulation of aspect 154, wherein the one or more additives include at least one of one or more rheology-modifying agents or one or more porosity-modifying agents.

Aspect 156. The formulation of any one of aspects 144-155, having a solids content from about 1% to 90%, the solids content comprising a mass of the plurality of nanoparticles and a mass of the one or more ligands in relation to a mass of the solvent.

Aspect 157. The formulation of any one of aspects 144-156, wherein the formulation is characterized as an ink.

Aspect 158. A method for producing a substrate including a nanostructured seed layer on one or more surfaces of a current collector comprising: providing an ink including a solution comprising at least one or more molecular precursors and a solvent; applying a thin wet film of the ink can be applied to the current collector, wherein the current collector comprises one or more polymeric materials; performing at least one of one or more thermal treatments or one or more chemical treatments to the thin wet film to produce a substrate comprising a free-standing, porous nanostructured seed layer on one or more surfaces of a current collector.

Aspect 159. The method of aspect 158, wherein the one or more molecular precurusors include one or more metalorganic nanoparticles.

Aspect 160. The method of aspect 159, wherein the ink is applied to the current collector using a solution-phase thin-film coating process.

Aspect 161. The method of any one of aspects 158-160, wherein at least a portion of pores in the nanostructured seed layer are backfilled with a solid electrolyte.

Aspect 162. The method of aspect 161, wherein the solid electrolyte comprises a solid polymer electrolyte.

Aspect 163. The method of aspect 162, wherein the solid polymer electrolyte comprises polyethylene oxide.

Aspect 164. The method of aspect 162, wherein the solid polymer electrolyte comprises one or more of the following polymers: polyethylene oxide (PEO), poly vinyl alcohol (PVA), poly methyl methacrylate (PMMA), poly dimethyl siloxane (PDMS), poly(ethylene glycol) dimethacrylate (PEGDMA), or poly vinyl pyrollidone (PVP).

Aspect 165. The method of aspect 161, wherein the solid electrolyte comprises a composite solid electrolyte comprising a polymer and inorganic filler.

Aspect 166. The method of aspect 165, wherein at least one of the polymer or the inorganic filler contribute to Li⁺ ion conductivity.

Aspect 167. The method of aspect 161, wherein the solid electrolyte comprises polyethylene oxide mixed with Li₇La₃Zr₂O₁₂.

Aspect 168. The method of aspect 161, wherein the solid electrolyte comprises a solid inorganic electrolyte.

Aspect 169. The method of aspect 168, wherein the solid inorganic electrolyte comprises one or more of Li_{w}LaₓM_{y}O₁₂ (where M is Nb, Ta, or Zr), LiₓMP_{y}S_{z} (where M is Ge or Sn), Li_{w}AlₓM_{y}(PO₄)₃ (where M is Ge or Ti), LiₓTi_{y}M_{z}(PO₄)₃ (where M is Cr, Ga, Fe, Sc, In, Lu, Y or La) or NaₓZr₂Si_{y}PO₁₂, x, y and z represent stoichiometric coefficients.

Aspect 170. The method of aspect 161, wherein the solid electrolyte comprises a lithium-containing salt and an organic solvent.

Aspect 171. The method of aspect 170, wherein organic solvent comprises at least one of ethylene carbonate, ethyl methyl carbonate, propylene carbonate, glyme, diglyme, dioxolane, vinylene carbonate, propane sultone, diethyl carbonate, dimethyl carbonate, or sulfolane.

Aspect 172. The method of aspect 170, wherein the organic solvent includes an ionic liquid.

Aspect 173. The method of aspect 172, wherein the ionic liquid comprises a quaternary phosphorous or a nitrogen cation.

Aspect 174. The method of aspect 173, wherein the ionic liquid comprises 1-ethyl-3-methyl imidazolium or 1-butyl-1-methyl pyrrolidinium.

Aspect 175. The method of aspect 170, wherein the lithium-containing salt includes at least one of lithium hexafluorophosphate, lithium perchlorate, lithium difluoro(oxalate)borate, lithium trifluoromethanesulfonate, lithium tetrafluoroborate, lithium bis(trifluoromethanesulfonimide), or lithium bis(fluorosulfonyl)imide.

Aspect 176. The method of any one of aspects 158-175, wherein the current collector comprises a foil.

Aspect 177. The method of any one of aspects 158-176, wherein the nanostructured seed layer is rendered electrically conductive by electroless plating with one or more metals.

Aspect 178. The method of any one of aspects 158-177, wherein a non-convective thermal treatment is performed in addition to or in lieu of a heat treatment or chemical treatment.

Aspect 179. The method of aspect 178, wherein the non-convective thermal treatment comprises laser-assisted sintering, microwave-assisted sintering, or optical flash sintering.

Aspect 180. The method of any one of aspects 158-179, wherein the seed layer is composed of at least two different types of nanoparticles wherein the at least two different nanoparticles are composed of different materials.

Aspect 181. The method of any one of aspects 158-179, wherein the seed layer is composed of core-shell nanoparticles, wherein the core is composed of one material and the shell is composed of a different material.

Aspect 182. The method of any one of aspect 158-181, comprising: forming an artificial solid-electrolyte interphase layer on at least a portion of the seed layer.

Aspect 183. The method of aspect 182, wherein the artificial solid-electrolyte interphase layer includes one or more monolayers.

Aspect 184. The method of aspect 182 or 183, wherein the artificial solid-electrolyte interphase layer includes a metallic material.

Aspect 185. The method of any one of aspects 182-184, wherein the artificial solid-electrolyte interphase layer includes a polymeric material.

Aspect 186. The method of any one of aspects 158-185, wherein the ink comprises a metal-organic precursor.

Aspect 187. The method of aspect 159, wherein the one or more nanoparticles are comprised of a metal.

Aspect 188. The method of aspect 187, wherein the metal possesses a bulk resistivity of 1×10⁻¹² Ohm-cm to 1 Ohm-cm.

Aspect 189. The method of aspect 159, wherein the one or more nanoparticles are comprised of a semiconductor.

Aspect 190. The method of aspect 189, wherein the semiconductor possesses a bulk resistivity of 1 Ohm-cm to 1000 Ohm-cm.

Aspect 191. The method of aspect 159, wherein the one or more nanoparticles are comprised of an insulator.

Aspect 192. The method of aspect 191, wherein the insulator possesses a bulk resistivity of 1000 Ohm-cm to 1×10¹³ Ohm-cm.

Aspect 193. The method of any one of aspects 159-192, wherein the one or more nanoparticles possess a spherical geometry.

Aspect 194. The method of any one of aspects 159-193, wherein the one or more nanoparticles possess a multi-faceted polyhedral geometry.

Aspect 195. The method of aspect 194, wherein the one or more nanoparticles possess a diameter between 1 Angstrom and 100 nm.

Aspect 196. The method of aspect 195, wherein any dimension of the nanoparticle polyhedral geometry possesses a length between 1 Angstrom and 100 nm.

Aspect 197. The method of any one of aspects 158-196, comprising adding organic molecules to the ink.

Aspect 198. The method of any one of aspects 158-197, wherein the dry film is subjected to one or more heat treatments ranging in temperature from 30 to 650° C.

Aspect 199. The method of aspect 198, wherein the one or more thermal treatments is performed in an ambient atmosphere containing gases composed of Nitrogen, Oxygen, Hydrogen, Argon, or some combination thereof.

Aspect 200. The method of aspect 199, wherein one or more of the gases are ionized.

Aspect 201. The method of any one of aspects 158-200, wherein the solution-phase coating process is a slot-die, spray, aerosol, bath, gravure, comma or dip coating process.

Aspect 202. The method of any one of aspects 158-201, wherein the ink further comprises a rheology-modifying agent or a porosity-modifying agent.

Aspect 203. The method of any one of aspects 158-202, wherein the porosity of the nanostructured seed layer ranges from 1%-99%.

Aspect 204. The method of any one of aspects 158-203, wherein the one or more chemical treatments comprises exposing the substrate to a bath containing a solution comprising a residual wash solvent and at least one chemical reagent.

Aspect 205. The method of aspect 204, wherein the bath is heated to a temperature between 30° C. and 300° C.

Aspect 206. The method of aspect 205, wherein the solution removes residual organic molecules in the nanostructured seed layer via a dissolution or depolymerization mechanism.

Aspect 207. The method of any one of aspects 158-206, wherein the one or more polymeric materials comprise at least one of polyethylene, polypropylene, polyimide, polyether ether ketone, polyester, polyamide, or polyethylene napthalate.

Aspect 208. The method of any one of aspects 158-207, wherein the one or more polymeric materials comprise one or more metals.

Aspect 209. The method of aspect 208, wherein the one or more metals comprise at least one of copper, titanium, nickel, or stainless steel.

Aspect 210. The method of any one of aspects 158-207, wherein the current collector is entirely composed of the one or more polymeric materials.

Aspect 211. The method of any one of aspects 158-210, wherein the nanostructured seed layer deposited on the current collector is electrically conductive.

### EXAMPLES

To illustrate the effectiveness of a nanoparticle seed layer, the following example is presented:
a. 2 nm diameter nanoparticles comprising a metallic material with spherical geometry are functionalized with an appropriate ligand and dispersed within an appropriate solvent such as THF along with pore-generating and rheology-modifying additives to generate a nanoparticle ink.
b. The ink is cast onto a foil current collector and residual solvent is evaporated under ambient conditions, leaving a “dry” film of ligand-functionalized nanoparticles.
c. Successive heat treatments with or without chemical treatments such as ligand dissolution are performed to convert the “dry” film into a free-standing nanoparticle matrix “seed layer” composed of necked nanoparticles remaining on top of the foil current collector. The ligands, additives, ink rheology and other ink design parameters are chosen such that the final seed layer after all heat treatments and chemical treatments is composed of ˜30% nanoparticle by volume, ˜70% open space by volume (porosity). The effective thickness of the seed layer at this composition (including porosity) is ˜32 um. The total pore volume per cm² of planar foil of the seed layer is ˜2.2×10⁻⁹ m³. The effective volume occupied by the seed layer (including porosity) per cm² of planar foil is ˜3.2×10⁻⁹ m³.
d. A “pre-deposition” process is then performed on the seed layer plus current collector (collectively, the “substrate”) wherein a ˜0.5 Angstrom thick layer of Li metal is uniformly deposited on nanoparticle surfaces from an electrodeposition bath comprising Li metal, Li salts and a combination of electrolytes.
e. The substrate is then combined with a cathode of areal capacity of 3 mAh/cm² and appropriate electrolyte, separator and housing to generate a battery cell. In such a cell, the substrate acts as the anode. Upon assembly, the electrolyte fills the pores of the seed layer, thereby providing diffusion pathways for Li ions throughout the seed layer.
f. The cell is charged to the full areal capacity of 3 mAh/cm². At this state-of-charge, the Li metal layer on all nanoparticle surfaces grows from 0.5 Angstrom to 4.5 Angstroms.
g. The effective volume of Li metal added to the nanoparticle surfaces totals ˜1.6×10⁻⁹ m³ per cm² of planar foil area, substantially less than the available pore volume of 2.2×10⁻⁹ m³ per cm² within the structure, thereby ensuring sufficient space to be occupied by the Li metal. Residual porosity after Li deposition is ˜0.6×10⁻⁹ m³ per cm² of planar foil area, corresponding to ˜19% of total volume occupied by seed layer. Porosity in the final film can be determined by a technique such as Brunauer-Emmett-Teller (BET) theory. This is slightly less than porosity in state-of-the-art Graphite anodes (˜25%). This residual volume is likely to be occupied by electrolyte and SEI.

In the above example, by limiting the growth of the Li metal layer to between 0.5 Angstroms and 4.5 Angstroms, any pre-formed SEI is likely to remain intact because it is not being excessively mechanically strained. As an example, typical 1-10 micron graphite particles in state-of-the-art LIB anodes swell by 10's to 100's of nm during lithiation, with little to no detrimental impact on the SEI.

In the above example, spherical geometry nanoparticles could be replaced by nanoparticles of alternate geometries, such as multi-faceted polyhedra or longer aspect ratio nanoparticles such as nanorods. Other multi-faceted polyhedra (like tetrahedra, for instance), are known to possess higher surface area to volume ratios than spheres. Furthermore, appropriately tailored nanoparticle geometry can help achieve a seed layer architecture that is optimized for high porosity, high surface area to total seed layer volume and high mechanical strength.

In the above example, the resulting thickness occupied by the nanoparticle seed layer (i.e., including porosity) is ˜32 microns, which is approximately 2× the minimum thickness that could be theoretically occupied by the same quantity of Lithium of the above example if deposited as a continuous film of bulk density. However, as previously described, electrodeposited Li metal films on planar current collectors during practical battery operation are far less dense than the bulk density of Li metal due to uneven, dendritic morphology. Furthermore, a 32-micron thick anode layer represents a substantial improvement in volumetric capacity over a corresponding state-of-the-art graphite layer paired with a 3 mAh/cm² cathode; such a graphite layer would normally exceed 80 microns in thickness.

In the above example, the nanoparticles are “monodisperse”, i.e., they all possess a diameter of 2 nm. In an alternative embodiment, the nanoparticles are “polydisperse”, i.e., they possess a range in diameter. In an alternative implementation, the nanoparticles are polydisperse and are not spherical, in which case they possess a range across whichever dimensions are specific to the geometry of the nanoparticle. Such polydispersity can further optimize the seed layer for high porosity, high surface area to total seed layer volume and high mechanical strength.

In one or more additional implementations, nanoparticles of various sizes are applied as multiple sequentially deposited layers instead of a single layer in order to tailor the microstructure and porosity of the seed layer. In such an implementation, some layers may be composed of larger nanoparticles and some may be composed of smaller nanoparticles. For example, the smaller nanoparticles may possess a size distribution with D50 of 1 nm, whereas the larger nanoparticles may possess a size distribution with D50 of 5 nm.

In one or more examples, the structure of the nanoparticle seed layer may be such that it leaves sufficient porosity for Li metal growth but insufficient room to also maintain high penetration of liquid electrolyte coupled with high levels of SEI growth. However, in state-of-the-art graphite anodes, it is known that several nm's of SEI grown on graphite surfaces contribute little added impedance to the cell. Therefore, even in circumstances where the porosity within the nanoparticle seed layer is mostly occupied by SEI, the diffusion of Li ions through SEI is sufficiently high such that the power capability of the cell is not necessarily negatively impacted.

In various examples, a nanoparticle seed layer may be infilled with some quantity of a solid polymer electrolyte such as polyethylene oxide (PEO) to provide ionic conductivity. In one or more implementations, the solid polymer electrolyte maintains high ionic conductivity within the pores of the seed layer while simultaneously preventing the excessive growth of SEI that often results from liquid electrolytes. Furthermore, solid polymer electrolytes are sufficiently elastic so as to easily accommodate growth of a Li metal layer between 0.5 and 4.5 Angstroms as in the above example. An infilled solid polymer electrolyte within a nanoparticle seed layer can also provide improved mechanical integrity to the seed layer, and it can also provide a physical barrier to atmospheric contaminants. As an example, in cases where the nanoparticle seed layer is composed of a metal that is easily oxidized in ambient air, a solid polymer electrolyte layer could act as a protective physical barrier against oxidation, which could reduce the electrical conductivity of the seed layer. In various examples, the infilled solid electrolyte can be comprised of a solid inorganic electrolyte. The solid inorganic electrolyte can be comprised of one or more of the following: Li_{w}LaₓM_{y}O₁₂ (where M is Nb, Ta, or Zr), LiₓMP_{y}S_{z} (where M is Ge or Sn), Li_{w}AlₓM_{y}(PO₄)₃ (where M is Ge or Ti), LiₓTi_{y}M_{z}(PO₄)₃ (where M is Cr, Ga, Fe, Sc, In, Lu, Y or La) or NaxZr₂SiyPO₁₂, where in all cases, x, y and z represent stoichiometric coefficients. In various examples, the infilled solid electrolyte can be comprised of a solid polymer electrolyte. The solid polymer electrolyte can comprise one or more of the following polymers: polyethylene oxide (PEO), poly vinyl alcohol (PVA), poly methyl methacrylate (PMMA), poly dimethyl siloxane (PDMS), poly(ethylene glycol) dimethacrylate (PEGDMA), poly vinyl pyrollidone (PVP). Such polymers, when combined with lithium salts such as LiClO₄, LiPF₆ or LiNO₃, among others, can yield a solid polymer electrolyte.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A device comprising:
a battery electrode including:
a substrate having one or more polymeric materials; and
a layer disposed on the substrate, the layer including one or more conductive materials, having a thickness no greater than 12 micrometers, and having a measure of porosity of at least 5% by volume.

2. The device of claim 1, wherein the one or more conductive materials include at least one of copper, aluminum, titanium, nickel, or stainless steel and are formed as a number of particles having at least one of a spherical morphology or a nanowire morphology.

3. (canceled)

4. The device of claim 1, wherein the one or more polymeric materials include at least one of a polyethylene, a polyethylene glycol, a polypropylene, a polyimide, a polyether ether ketone, a polyester, polyethylene terephthalate, a polyamide, a polyvinylchloride, a polyacrylate, or a polyethylene naphthalate.

5. (canceled)

6. (canceled)

7. The device of claim 1, wherein the layer includes one or more electrode active materials that correspond to an anode and comprise at least one of graphite, Si, Sn, Ge, Al, P, Zn, Ga, As, Cd, In, Sb, Pb, Bi, SiO, SnO₂, Si, Sn, lithium metal, LiNiₓMn_{y}Co_{z}O₂, LiNiₓCo_{y}Al_{z}O₂, LiMnₓNi_{y}O₂, LiMnO₂, LiFePO₄, LiMnPO₄, LiNiPO₄, LiCoPO₄, LiV₂O₅, sulfur or LiCoO₂ where x, y and z are stoichiometric coefficients.

8. (canceled)

9. The device of claim 7, wherein the layer includes one or more binding materials to cause the one or more electrode active materials to bind with the one or more conductive materials, the one or more binding materials including at least one of a polyvinylidene fluoride, a polyamide imide, a polyethylene oxide, a polyimide, a poly (acrylic acid), a poly (methyl methacrylate), a polyvinyl alcohol, or a polypropylene carbonate.

10. (canceled)

11. The device of claim 9, wherein the layer includes one or more conductive additives comprising at least one of carbon black particles, carbon nanotubes, or graphite particles.

12. The device of claim 1, wherein the layer is a current collector layer and the battery electrode includes an active material layer comprising one or more electrode active materials.

13. The device of claim 1, wherein the layer includes pores having diameters no greater than 10 nanometers and the substrate has a porosity of at least 5% by volume.

14. (canceled)

15. The device of claim 1, wherein an encapsulating thin layer is formed on the one or more conductive materials.

16. The device of claim 1, wherein the layer includes one or more fire retardant additives comprised of at least one of ammonium polyphosphate, ammonium sulfate, sodium borate, melamine, or pentaerythritol.

17. The device of claim 1, wherein the layer includes one or more thermal management additives comprised of at least one of a polyethylene, a polypropylene, a polystyrene, a polyethylene terephthalate, a polytetrafluoroethylene, a polycarbonate, a polyvinyl chloride, an ethylene-vinyl acetate, a polyvinyl alcohol, a polycaprolactone, silicone, a polyurethane, or naphthalene.

18. (canceled)

19. A method comprising:
providing a substrate for a battery electrode, the substrate including one or more polymeric materials, and
forming a layer on the substrate, wherein the layer includes one or more conductive materials, having a thickness no greater than 12 micrometers, and has a measure of porosity of at least 5% by volume.

20. The method of claim 19, wherein forming the layer on the substrate includes depositing an ink on the substrate, and the method comprises:
applying one or more thermal treatments to the ink after the ink is deposited on the substrate, wherein the one or more thermal treatments are performed at temperatures no greater than about 250° C.

21. (canceled)

22. The method of claim 19, comprising:
performing a solution-phase coating process to form the layer on the substrate;
wherein the solution-phase coating process includes at least one of a slot-die process, a spray process, an aerosol process, a bath process, a gravure coating process, a comma coating process, or a dip coating process.

23. The method of claim 20, wherein the ink includes first particles comprised of the one or more conductive materials and one or more solvents, wherein the one or more solvents include at least one of isopropyl alcohol, ethanol, methanol, tert-butanol, 1-butanol, 2-Amino-2-methyl-1-propanol, amino-2-propanol, 2-methoxyethanol, ethylene glycol, dipropylene glycol monomethyl ether, diethylene glycol methyl ether, benzyl alcohol, pyridine, tetrahydrofuran (THF), hexane, toluene, or water.

24. (canceled)

25. The method of claim 23, wherein the ink includes second particles comprising one or more electrode active materials.

26. The method of claim 20, wherein the layer is a current collector layer, and the method comprises:
forming an active material layer on the current collector layer, the active material layer comprising an active material of the battery electrode by depositing an additional ink on the current collector layer; and
applying one or more additional thermal treatments to the additional ink after the additional ink is deposited on the current collector layer, wherein the one or more additional thermal treatments are performed at temperatures no greater than about 250° C.

27. (canceled)

28. (canceled)

29. The method of claim 26, comprising:
performing an additional solution-phase coating process to form the active material layer on the current collector layer, wherein the additional solution-phase coating process includes at least one of a slot-die process, a spray process, an aerosol process, a bath process, a gravure coating process, a comma coating process, or a dip coating process.

30. The method of claim 19, comprising performing one or more pretreatment processes with respect to the substrate prior to forming the layer on the substrate, the one or more pretreatment processes including at least one of ultraviolet-ozone, corona discharge, atmospheric plasma, or applying one or more chemical solutions to the substrate.

31. The method of claim 19, comprising performing one or more thermal treatments with respect to at least one of the one or more conductive materials or one or more conductive material-active electrode material complexes disposed on the substrate, the one or more thermal treatments including at least one of optical flash sintering, spark plasma sintering, ultrasonic sintering, or microwave sintering.

32.-34. (canceled)
